(19) United States
(12) Patent Application Publication
(10) Pub. No.: US 2025/0273096 A1
(43) Pub. Date: Aug. 28, 2025

(54) WHITEBOARD SUBSTRATE WITH MOUNTING BASE

(71) Applicant: TeacherGeek, Inc., Holley, NY (US)

(72) Inventor: Darren COON, Holley, NY (US)

(21) Appl. No.: 19/206,667

(22) Filed: May 13, 2025

Related U.S. Application Data
(63) Continuation-in-part of application No. 18/858,185, filed on Oct. 18, 2024, now Pat. No. 12,324,521.
(60) Provisional application No. 63/764,551, filed on Feb. 27, 2025.

(51) Int. Cl. G09F 7/18; B43L 1/00; B43L 3/00

(52) U.S. Cl. CPC G09F 7/18; B43L 1/00; B43L 3/008; G09F 2007/1873

(57) ABSTRACT

A customizable play character system includes a play character and a base. The play character is formed from a semi-flexible substrate with printed indicia forming an internal design on the substrate's design face. An outer edge of the substrate forms a design outline, and the internal design and the design outline combine to create a first character. A stabilizing contour is formed along the bottom edge of substrate. The base has a top, a bottom, and an outer wall, and a contoured retention slot for receiving the play character. The contoured retention slot has a plurality of contact nodes structured to create a flexural deformation in the semi-flexible substrate when inserted into the slot. In some embodiments, the base is configured with a plurality of retention slots.

### CROSS-REFERENCE TO RELATED APPLICATIONS

This application is a continuation-in-part of and claims priority pursuant to 35 U.S.C. § 120 to U.S. application Ser. No. 18/858,185, filed Oct. 18, 2024, which application is a 35 U.S.C. § 371 nationalization of International Patent Application No. PCT/2022/071821, filed on Apr. 20, 2022, which applications are incorporated herein by reference in their entireties. This application also claims priority pursuant to 35 U.S.C. § 119 to U.S. Provisional Patent Application No. 63/764,551, filed Feb. 27, 2025, which application is incorporated by reference herein in its entirety.

### FIELD

The present disclosure relates to a decorative whiteboard having printed indicia defining coloring areas to form a play character and a mounting base designed for upright orientation of the play character.

### BACKGROUND

Children have always been encouraged to color “between the lines” as a tool to develop fine motor skills in their writing hands. However, children are prone to coloring on objects that are undesirable, such as walls or carpets. Children also like to proudly display their work-for example, when a parent or guardian displays a completed piece on a fridge. Whiteboards can be hung on walls, but generally are plain in shape and lack the artistic composition that children's coloring books have. Moreover, mounting a large whiteboard on a wall can be a difficult task as it is nearly impossible to see the mounting locations on the respective wall during installation and otherwise, require a large easel.

Conventional dry-erase boards feature a smooth surface optimized for use with dry-erase markers. However, such surfaces are poorly suited for use with wax-based or pigment-based crayons, which require a surface texture-commonly referred to as “tooth”-for effective color deposition and adherence.

Conventional play in the toy industry has predominantly relied upon pre-designed action figures and character toys created by adults for children's imaginative engagement. These commercially available toys, while designed to stimulate creativity, paradoxically impose significant limitations on children's imagination through their fixed appearances, predetermined identities, and manufacturer-prescribed play patterns.

This inherent limitation reflects a fundamental tension in childhood development between guided and open-ended learning approaches, where the open-ended approach could result in some of the aforementioned issues, especially with coloring. Traditional action figures provide structural scaffolding for play by offering familiar starting points and reference frameworks that children can readily engage with. However, excessive predefinition in toy design restricts the expansiveness of a child's imaginative capabilities and self-directed play exploration. A solution providing a balance between the two paradigms is needed.

Among the known play figures and dolls are those described in U.S. Pat. No. 5,178,573 (magnetic paper doll set), U.S. Pat. No. 8,512,080 (three-dimensional posable character), U.S. Pat. No. 5,040,478 (poseable, erasable drawing toy), and U.S. Pat. No. 4,280,289 (writing doll apparatus). These prior art devices, while offering various forms of customization, do not provide the comprehensive solution of the present invention that combines a dry-erase surface with a semi-flexible character design and specialized base system to create a truly adaptive play experience.

Thus, there is a long-felt need for an apparatus that allows children to practice coloring “between the lines” that comes in a variety of different designs which can also be mounted on a wall for display.

There is another long-felt need for a simple mounting base that securely but removably allows fixtures to be displayed in an upright position, which is also structurally designed to accommodate use by children and while the fixtures themselves are configured to help support an upright display.

There is a further long-felt need for a dry-erase surface that doesn't minimize tooth, allowing for effective color deposition and adherence of wax-based or pigment-based crayons.

### SUMMARY

In an illustrative aspect, the present invention may comprises a whiteboard having a semi-flexible substrate having an outwardly facing design surface of a first color and an opposing inwardly facing surface, the outwardly facing design surface having an outer border about the entire perimeter thereof, the outer border comprising printed indicia of a second color which contrasts with the first color, wherein the outer border defines the shape of an object, the outwardly facing design surface further comprising at least one inner border, wherein the at least one inner border intersects at least the outer border at two points, or intersects at least one inner border at one point and the outer border at one point, or intersects at least one other inner border at one point and a different inner border at a second point, wherein each of the at least one inner border comprises printed indicia of a third color which contrasts with the first color, wherein the inner and outer borders intersect one another in such a way as to create discrete portions of the design surface and function as to create lines of demarcation between adjacent portions to define a surface area of the portions to be filled with a specific color of removable printed indicia.

According to an illustrative embodiment of the invention, a whiteboard comprises a semi-flexible substrate having an outwardly facing design surface of a first color and an opposing inwardly facing surface, said outwardly facing design surface having an outer border about the entire perimeter thereof, said outer border comprising printed indicia of a second color which contrasts with said first color, wherein said outer border defines the shape of an object, said outwardly facing design surface further comprising at least one inner border, wherein said at least one inner border intersects at least said outer border at two points, or intersects at least one inner border at one point and said outer border at one point, or intersects at least one other inner border at one point and a different inner border at a second point, wherein each of said at least one inner border comprises printed indicia of a third color which contrasts with said first color, wherein said inner and outer borders intersect one another in such a way as to create discrete portions of said design surface and function as to create lines of demarcation between adjacent portions to define a surface area of said portions to be filled with a specific color of removable printed indicia. This provides a means for children to practice their fine motor skills.

According to a contemplated embodiment of the invention, a character display system comprises the whiteboard recited and further comprising a base adapted to removable accept the whiteboard therein, the base comprising a body with a top face and a bottom face, and a contoured retention slot arranged within the top face of the body and having a pair of openings arranged on peripheral edges of the body. This provides a system for both drawing and displaying the work of children.

According to a possible embodiment of the invention, the contoured retention slot comprises a first internal wall, a second internal wall, and a floor, one or more of the first internal wall or the second internal wall having at least one contact node extending therefrom. This provides a better retention of the whiteboard to the base.

According to an exemplary embodiment of the invention, the contoured retention slot comprises a first internal wall, a second internal wall, and a floor, each of the internal walls having at least one contact node extending therefrom. This provides for a more reliable retention.

According to an illustrative embodiment of the invention, the whiteboard comprises a bottom edge, the bottom edge configured with a stabilizing contour defined by a non-linear arrangement of the bottom edge. This provides a means for the whiteboard not to tip over.

According to a contemplated embodiment of the invention, a character display system comprises a play character comprising a semi-flexible substrate and printed indicia forming an internal design on the semi-flexible substrate, wherein an outer edge of the semi-flexible substrate forms a design outline, and wherein the internal design and the design outline form a first character, and a stabilizing base contour extending from lowest bottom corners upward to a middle point along the bottom edge of the semi-flexible substrate, and a base comprising at least one contoured retention slot configured to receive the play character, the contoured retention slot comprising a plurality of contact nodes. This provides a toy that can be customized and will not tip over.

According to a possible embodiment of the invention, the semi-flexible substrate comprises a semi-flexible polymeric material. This makes the product safer for children and affords a secure and removable connection with the base.

According to an exemplary embodiment of the invention, the stabilizing base contour is configured to maintain planar contact equilibrium with a play surface. This provides a stable toy that is not easily knocked over.

According to an illustrative embodiment of the invention, the play character further comprises a dry-erase coating on at least one face. This allows for the toy to be customized over and over again.

According to a contemplated embodiment of the invention, the dry-erase coating is configured to be compatible with dry-erase markers and dry-erase crayons. This allows children to use different types of markers to customize the toy.

According to a possible embodiment of the invention, at least one face with the dry-erase coating has a textured surface configured to enhance adherence of dry-erase crayons. This makes the toy more aesthetically pleasing.

According to an exemplary embodiment of the invention, the textured surface comprises a plurality of irregularities. This provides a more reliable means for the crayons to adhere to the surface.

According to an illustrative embodiment of the invention, a character display system comprises a play character comprising a semi-flexible substrate and printed indicia forming an internal design on the semi-flexible substrate, wherein an outer edge of the semi-flexible substrate forms a design outline, and wherein the internal design and the design outline form a first character, and a base comprising at least one contoured retention slot configured to receive the play character, the contoured retention slot comprising a first wall, a second wall, and a floor, wherein one or more of the first wall or the second wall comprise one or more contact nodes. This provides a toy that can be easily assembled and disassembled.

According to a contemplated embodiment of the invention, the play character further comprises a stabilizing base contour extending from lowest bottom corners upward to a middle point along the bottom edge of the semi-flexible substrate. This provides a non-tipping toy.

According to a possible embodiment of the invention, the play character further comprises one or more of a dry-erase coating on at least one face, or a textured surface configured to enhance adherence of dry-erase crayons on the at least one face. This allows for a toy that can be customized and allow for different types of writing utensils.

According to an exemplary embodiment of the invention, the textured surface comprises a plurality of irregularities. This allows the crayon to properly write on the board.

According to an illustrative embodiment of the invention, the plurality of irregularities comprise teeth. This provides for a surface for the crayon to properly grip.

According to a contemplated embodiment of the invention, the each of the teeth are configured as a rolling mountain. This allows for the crayon to properly grip without damage.

According to a possible embodiment of the invention, the plurality of irregularities on the textured surface have an average spacing between 5 micrometers and 20 micrometers. This provides for optimal crayon adherence.

According to an exemplary embodiment of the invention, the plurality of irregularities on the textured surface have an average height between 1 micrometer and 10 micrometers. This provides for optimal crayon adherence.

These and other objects, features, and advantages of the present disclosure will become readily apparent upon a review of the following detailed description of the disclosure, in view of the drawings and appended claims.

### BRIEF DESCRIPTION OF THE DRAWINGS

Various embodiments are disclosed, by way of example only, with reference to the accompanying schematic drawings in which corresponding reference symbols indicate corresponding parts, in which:

FIG. 1A is a first representative design of the present invention;

FIG. 1B is a second representative design of the present invention;

FIG. 1C is a third representative design of the present invention;

FIG. 1D is a fourth representative design of the present invention;

FIG. 1E is a fifth representative design of the present invention;

FIG. 1F is a sixth representative design of the present invention;

FIG. 2 is a front view of the first embodiment of the first representative design of the present invention with the lines of demarcation removed from within outer border 20;

FIG. 3 is a front view of the first embodiment of the first representative design of the present invention;

FIG. 4 is a rear perspective view of whiteboard 500;

FIG. 5A is a top perspective view of star socket 100;

FIG. 5B is a bottom perspective view of star socket 100;

FIG. 5C is a top plan view of star socket 100;

FIG. 5D is a bottom plan view of star socket 100;

FIG. 6A is a partial perspective view of star socket 100 mounted to mounting face 12 taken from FIG. 4;

FIG. 6B is a left side view of FIG. 6A;

FIG. 6C is a sectional view taken along lines 6C-6C shown in FIG. 6B with a detailed section of star socket 100;

FIG. 7A is a top perspective view of stud plate 200;

FIG. 7B is a bottom perspective view of stud plate 200;

FIG. 7C is a top plan view of stud plate 200;

FIG. 7D is a bottom plan view of stud plate 200;

FIG. 8A is a left side view of stud plate 200 shown in FIG. 7A;

FIG. 8B is a sectional view of stud plate 200 taken along lines 8B-8B shown in FIG. 8A;

FIG. 9A is a top perspective view of star socket 100 engaged to stud plate 200;

FIG. 9B is a bottom perspective view of star socket 100 engaged to stud plate 200;

FIG. 9C is a left side view of FIG. 9A;

FIG. 10 is a cross-sectional view taken along lines 10-10 shown in FIG. 9C;

FIG. 11A is a cross-sectional view of the present invention and a wall during a first step in the installation;

FIG. 11B is a cross-sectional view of the present invention and a wall during a second step in the installation;

FIG. 11C is a cross-section view of the present invention and a wall during a third step in the installation;

FIG. 11D is a cross-sectional view of the present invention and a wall when completely installed;

FIG. 12 is a cross-sectional view of star socket 100 secured to whiteboard 500 and stud plate 200 secured to wall 400;

FIG. 13A is a side view of whiteboard 500 secured to wall 400;

FIG. 13B is a cross-sectional view taken along lines 13B-13B shown in FIG. 13A;

FIG. 14A is a perspective view of a first alternative embodiment of the star socket of the present invention;

FIG. 14B is a perspective view of a second alternative embodiment of the star socket of the present invention;

FIG. 15A is a perspective view of a first alternative embodiment of the stud plate of the present invention;

FIG. 15B is a perspective view of a third alternative embodiment of the star socket of the present invention;

FIG. 16A is a perspective view of a fourth alternative embodiment of the star socket of the present invention;

FIG. 16B is a bottom perspective view of a fourth alternative embodiment of the star socket of the present invention;

FIG. 17A is a cross-sectional view of star socket 900 taken along lines 17A-17A shown in FIG. 16A

FIG. 17B is a front view of the star socket shown in FIG. 17A;

FIG. 18A illustrates a perspective view of star socket 100 with screw positioning foam 50 within aperture 110;

FIG. 18B illustrates a side view of star socket 100 with screw positioning foam 50 within aperture 110;

FIG. 18C illustrates a side view of screw positioning foam 50 within star socket 100 being adhered to a wall;

FIG. 18D illustrates a side view of screw positioning foam 50 adhered to a wall;

FIG. 19A illustrates a character coloring and display system of the present invention;

FIG. 19B is a side view of the invention shown in FIG. 19A;

FIG. 19C is a top view of the invention shown in FIG. 19A;

FIG. 19D is a perspective of the invention shown in FIG. 19A;

FIGS. 20A through 20D illustrate a base of the invention shown in FIG. 19A;

FIG. 21 is an exploded view of a representation of the invention shown in FIG. 19A;

FIG. 22A is a perspective assembled view of the invention shown in FIG. 21;

FIG. 22B is an enlarged view taken from FIG. 22A;

FIG. 22C is a representative cross-section view of FIG. 22B;

FIG. 23 is a top assembled view of the invention shown in FIG. 21;

FIG. 24 is a front view of a character of the system shown in FIG. 19A;

FIGS. 25A and 25B are front views of the system shown in FIG. 19A;

FIGS. 26A and 26B are front views of the system of the present invention with an alternative embodiment of the character of the system shown in FIG. 19A;

FIGS. 27A through 27C illustrate a problem configuration that is avoided by the system shown in FIGS. 26A and 26B;

FIG. 28A illustrates a front view of the character shown in FIGS. 26A and 26B;

FIG. 28B illustrates a front view of the system shown in FIGS. 26A and 26B;

FIGS. 29A and 29B illustrate alternative base positions of the system shown in FIGS. 26A and 26B;

FIGS. 30A and 30B illustrate a first alternative embodiment of the base shown in FIG. 20A; and,

FIG. 31A and 31B illustrate a second alternative embodiment of the base shown in FIG. 20A.

### DETAILED DESCRIPTION

At the outset, it should be appreciated that like drawing numbers on different drawing views identify identical, or functionally similar, structural elements. It is to be understood that the claims are not limited to the disclosed aspects. Further, those in the art will understand that any suitable material, now known or hereafter developed, may be used in forming the present invention described herein.

Furthermore, it is understood that this disclosure is not limited to the particular methodology, materials and modifications described and as such may, of course, vary. It is also understood that the terminology used herein is for the purpose of describing particular aspects only and is not intended to limit the scope of the claims.

The word “example” or “exemplary” is used herein to mean “serving as an example, instance, or illustration.” Any implementation described herein as “exemplary” is not necessarily to be construed as preferred or advantageous over other implementations.

If the specification states a component or feature “may,” “can,” “could,” “should,” “would,” “preferably,” “possibly,” “typically,” “optionally,” “for example,” “often,” or “might” (or other such language) be included or have a characteristic, that a specific component or feature is not required to be included or to have the characteristic. Such a component or feature may be optionally included in some embodiments, or it may be excluded.

Unless defined otherwise, all technical and scientific terms used herein have the same meaning as commonly understood to one of ordinary skill in the art to which this disclosure pertains. It should be understood that any methods, devices or materials similar or equivalent to those described herein can be used in the practice or testing of the example embodiments.

It should be appreciated that the term “substantially” is synonymous with terms such as “nearly,” “very nearly,” “about,” “approximately,” “around,” “bordering on,” “close to,” “essentially,” “in the neighborhood of,” “in the vicinity of,” etc., and such terms may be used interchangeably as appearing in the specification and claims. It should be appreciated that the term “proximate” is synonymous with terms such as “nearby,” “close,” “adjacent,” “neighboring,” “immediate,” “adjoining,” etc., and such terms may be used interchangeably as appearing in the specification and claims. The term “wall” is intended to mean any of various permanent upright constructions having a length greater than its thickness and presenting a continuous surface except where pierced by doors, windows, etc. It is intended to include well-known wallboard having planar surface but can also include structures having non-planar (curved) or irregular surfaces.

It should also be appreciated that directional terms used herein are relative to the corresponding figure being described. For example, “leftward” or “rightward”, “top” or “bottom”, are relative to the figure as illustrated on a particular sheet, therefore “leftward” is referring to the left side of an illustration as depicted.

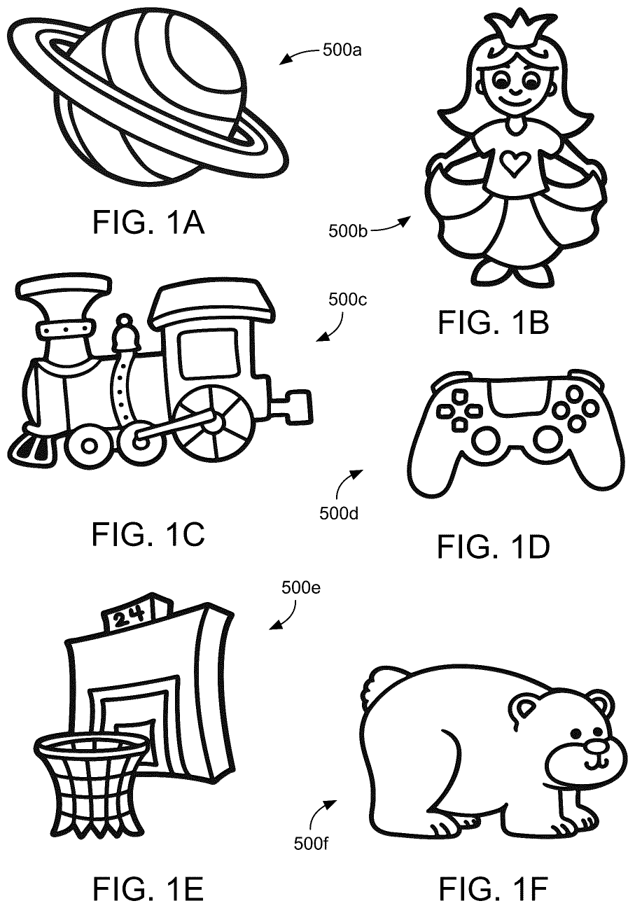

Referring now to the figures, the following description should be taken in view of FIGS. 1A-IF. At the outset, it should be appreciated that the present invention relates to “designs” where a design is intended to mean a graphic image of a person, place, animal, object or thing. The claims are not intended to be limited to any one particular design, although, for purposes of explanation and understanding, a plurality of representative designs are illustrated in the drawings and described herebelow. FIG. 1A shows first design 500a of the present invention (this first design happens to be a graphic representation of the planet Saturn, although it should be appreciated that the claims are not limited to this particular design.) FIG. 1B shows second design 500b of the present invention (this second design happens to be a graphic representation of a princess wearing a dress, although it should be appreciated that the claims are not limited to this particular design.) FIG. 1C shows third design 500c of the present invention (this third design happens to be a graphic representation of a train engine, although it should be appreciated that the claims are not limited to this particular design.) FIG. 1D shows fourth design 500d of the present invention (this fourth design happens to be a graphic representation of a video game controller, although it should be appreciated that the claims are not limited to this particular design.) FIG. 1E shows fifth design 500e of the present invention (this fifth design happens to be a graphic representation of a basketball backboard and shot clock, although it should be appreciated that the claims are not limited to this particular design.) FIG. 1F shows sixth design 500f of the present invention (this sixth design happens to be a graphic representation of a toy bear standing on all four legs, although it should be appreciated that the claims are not limited to this particular design.) It should be appreciated that designs 500a-500f are merely exemplary, and the designs and details of the present invention may vary greatly to depict different shapes or figures.

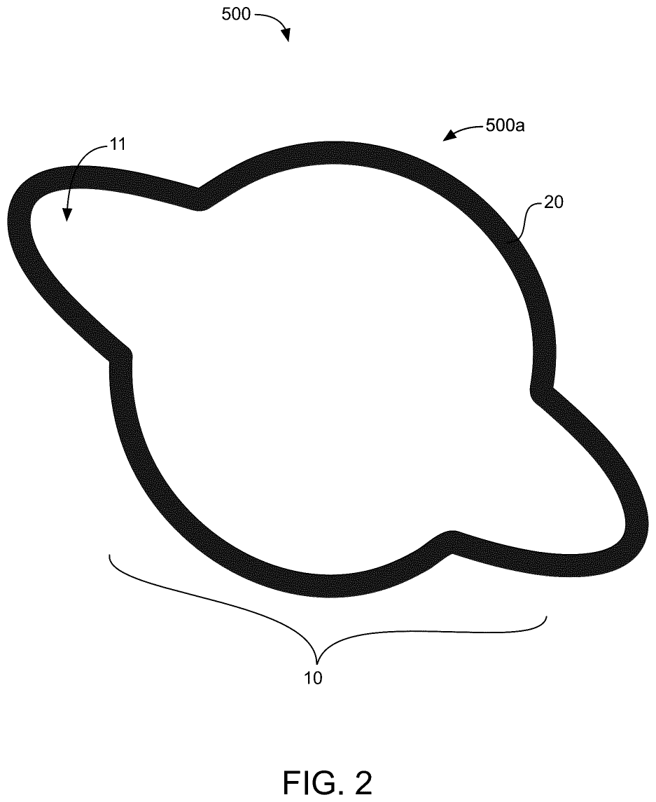

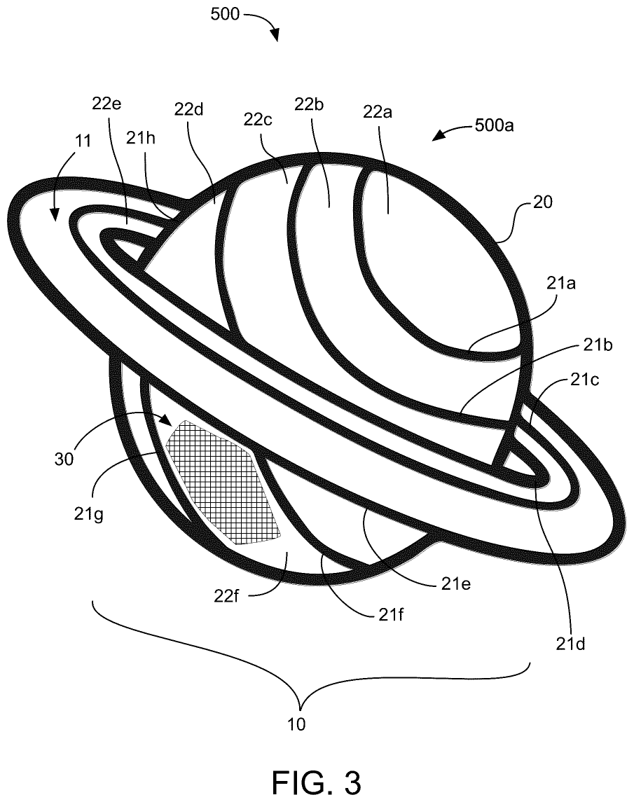

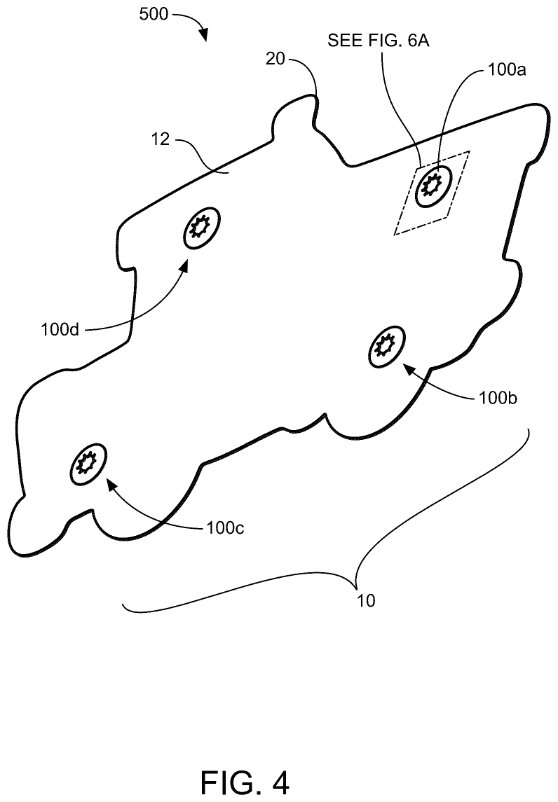

The following description should be taken in view of FIGS. 2 and 3. FIG. 2 shows whiteboard 500, specifically first design 500a. It should be appreciated that in FIG. 2, the internal borders (shown in FIG. 3) are removed from first design 500a of whiteboard 500 and only outer border 20 of design 500a is shown. It should be appreciated that outer border 20 defines the outer perimeter of the specific shape of designs 500a-500f, shown in FIGS. 1A-IF. Outer border 20 has a thickness, or weight, that is arranged to contrast with the color of substrate 10 of whiteboard 500. The color of substrate 10 is defined by a first color and outer border 20 is defined by a second color. The first color of substrate 10 is arranged on design face 11 of whiteboard 500. Substrate 10 includes two surfaces, or faces, design face 10 and mounting face 12 (shown in FIG. 4 and described, infra). For example, the outer border might be black and the substrate might be white; the outer border might be green, blue, red, orange and the substrate might be white, yellow or pink. The claims are not intended to be limited to any specific combination of colors for the border and the substrate as a myriad of color combinations are possible as long as the border color contrasts with the substrate color.

Arranged within outer border 20 are a plurality of lines of demarcation, 21a-21g. Lines of demarcation 21a-21g are defined by having a third color which is arranged to contrast with the first color of substrate 10. In some embodiments, the second color of outer border 20 of whiteboard 500 may be the same as the third color of lines of demarcation 21a-21g.

Lines of demarcation 21a-21h and outer border 20 are arranged to define a plurality of closed shapes having a fill color which is the color of substrate 10. Lines of demarcation 21a-21g are also arranged to define closed shapes having a fill color of substrate 10 which are not bounded by outer border 20. For example, outer border 20 and line of demarcation 21a define shape 22a on design face 11; outer border 20, line of demarcation 21a and line of demarcation 21b define shape 22b; line of demarcation 21c, line of demarcation 21d, and line of demarcation 21h define shape 22e. Outer border 20 and lines of demarcation 21a-21h define a border of the shapes they respectively create having either the second color, the third color, or a combination of the second and third color, such that the border of the respective shape will contrast with the first color of the substrate 10.

How the respective shapes are formed on design face 11 depends on a selected arrangement of the intersections of lines of demarcation 21a-21h with outer border 20, or the intersections of lines of demarcation 21a-21h with another line of demarcation. A select number of the lines of demarcation will intersect with outer border 20, e.g., line of demarcation 21a intersects outer border 20 at the respective ends of line of demarcation 21a. A select number of lines of demarcation will intersect with outer border 20 at one end and will intersect with another line of demarcation at its opposite end, e.g., line of demarcation 21h intersects outer border 20 at one of its ends and intersects line of demarcation 21d at its opposite end. A select number of lines of demarcation will intersect with other lines of demarcation within outer border 20, e.g., line of demarcation 21d only intersects with other lines of demarcation and not outer border 20.

Shapes 22a-22f designate areas where removable markings should be applied to design face 11 of substrate 10 of whiteboard 500. For example, outer border 20 and lines of demarcation 21e-21g define shape 22f and indicate area for marking 30 to be made within the border of shape 22f. It should also be noted that the entirety of design face 11 may accept removable markings, however, shapes 22a-22f are the preferred marking areas to encourage children to develop good habits. More concisely, the designated arcas bordered by any combination of outer border 20 with one or more lines of demarcation, or bordered by a plurality of internal lines of demarcation alone define areas where children would typically “draw within the lines” as they would in a conventional paper coloring book.

Outer border 20 and lines of demarcation 21a-21h define high-contrast borders of shapes on design face 11. The shapes indicate areas to be colored by children using removable markings on design face 11 such as dry-erase markers or dry-erase crayons, or other removable marking means. The high-contrast borders of the shapes on design face 11 encourage children to “color within the lines”.

It should be noted that alternatively, lines of demarcation 21a-21h may be the same color as design face 11 of substrate 10 and that shapes 22a-22f are printed onto design face having a different color than lines of demarcation 21a-21h. The alternative method of production still produces a high-contrast color bifurcation of lines of demarcation 21a-21h and shapes 22a-22f.

FIG. 4 illustrates a rear perspective view of whiteboard 500. Mounting face 12 of whiteboard 500, as shown in FIG. 4, is opposite design face 11. In operation the mounting face functions to secure the whiteboard to a surface, such as a wall. Mounting face 12 includes a plurality of star sockets 100a-100d mounted thereon. Star sockets 100a-100d are secured to mounting face 12 via ultrasonic welding, chemical bonding, spin welding, laser welding, or other acceptable non-removable means.

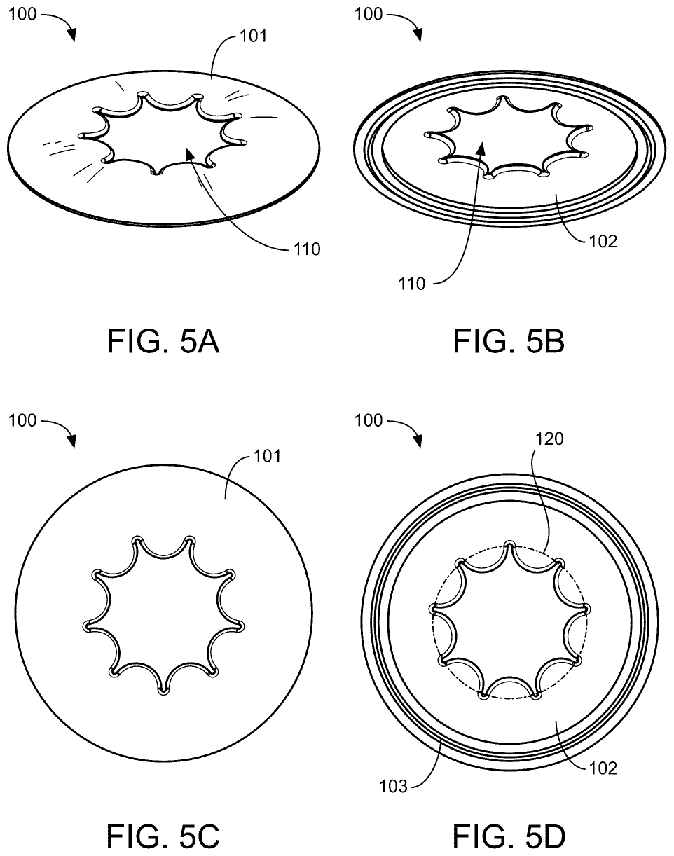

The following description should be taken in view of FIGS. 5A-5D, which illustrate a plurality of views of star socket 100. Star socket 100 generally comprises contoured external face 101, internal face 102, base 103, aperture 110, and plurality of tabs 120 that define the external border of aperture 110. It should be appreciated that external face 101, internal face 102, and base 103 are integral components of star socket 100. Base 103 is an annular ring that protrudes from internal face 102, arranged proximate to the external border of star socket 100. Contoured external face 101 extends from base 103 and is arranged to have a contoured shape, where the contour, or curvature, is arranged in a direction away from base 103 and proximate aperture 110. In other words, contoured external face 101 has a contour that slopes, or curves, in a direction out and away from mounting face 12 (shown in FIG. 4) and base 103, whereas base 103 is secured on mounting face 12 (shown in FIG. 4).

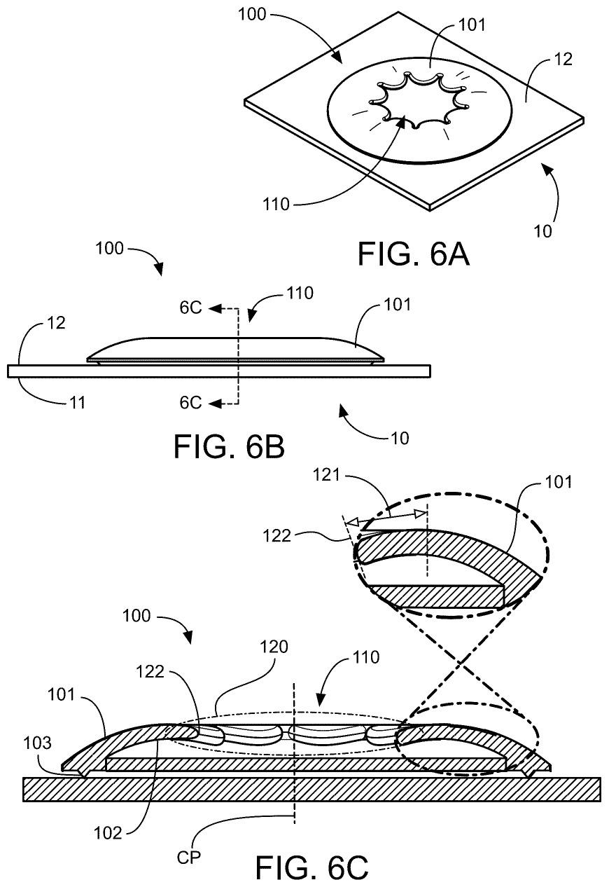

The following description should be taken in view of FIGS. 6A-6C. FIG. 6A is a partial view of star socket 100a and mounting face 12 of substrate 10 shown in FIG. 4. It should be appreciated that star socket 100a is referenced by numeral 100 in FIGS. 6A-6C and the following description applies to star sockets 100a-100d, shown in FIG. 4. In a preferred embodiment, star socket 100 is fixedly secured to mounting face 12 of substrate 10. The contoured shape of contoured external face 101 is best shown in FIGS. 6B and 6C. The contoured shape of contoured external face 101 terminates at the beginning of contoured section 121 of plurality of tabs 120, best shown in FIG. 6C. Contoured section 121 of each tab of plurality of tabs 120 are arranged to contour in the direction towards base 103. Contoured section 121 begins where the contour of contoured face 101 ends, and contoured section 121 terminates at each rounded end 122 of each tab of plurality of tabs 120. It should also be appreciated that plurality of tabs 120 each terminate proximate to center point CP of base 103.

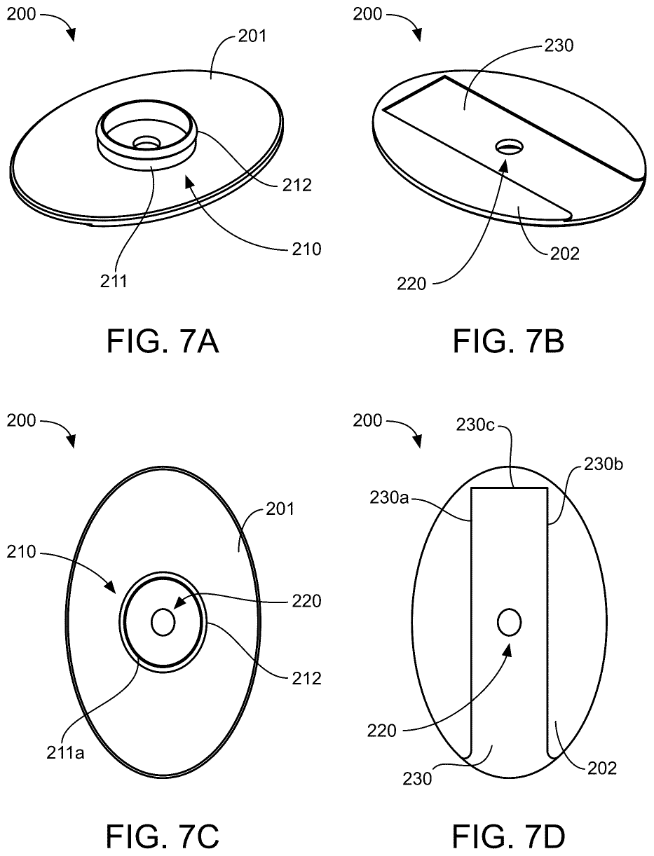

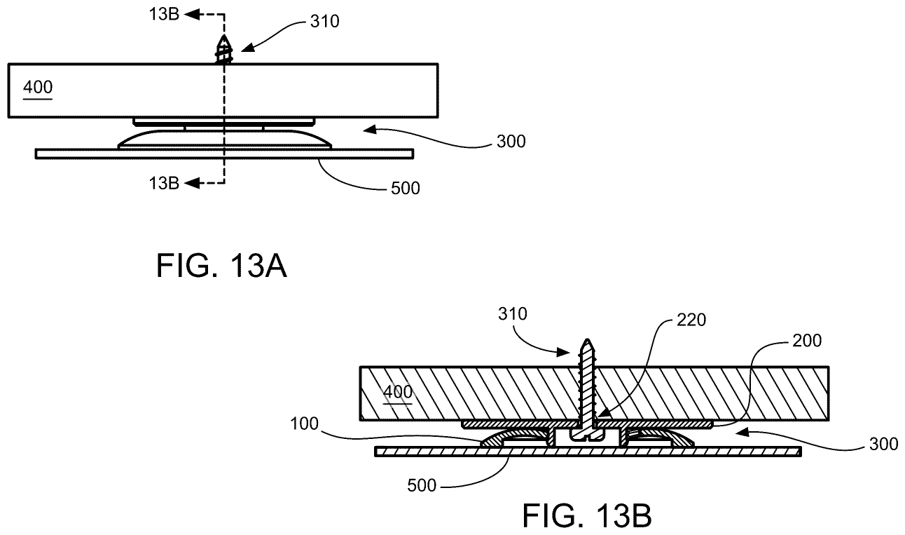

The following description should be taken in view of FIGS. 7A-7D, which illustrate a plurality of views of stud plate 200. Stud plate 200 generally comprises external face 201, mounting face 202, stud 210, and mounting aperture 220. External face 201, mounting face 202, and stud 210 are all integral components of stud plate 200. Stud 210 comprises body 211, which is arranged to extend from external face 201, and annular ring 212, which is arranged to circumscribe the outer surface of body 211 and protrude outwardly. Mounting face 202 includes mounting channel 230, which is a cut out section that includes the open end of mounting aperture 220 on mounting face 202. Mounting channel 230 is defined by three edges: first edge 230a, second edge 230b, and third edge 230c. Mounting channel 230 is arranged to seat an adhesive strip therein, such that alternatively, stud plate 200 may be mounted via an external adhesive instead of a mounting screw (discussed in view of FIGS. 13A and 13B, infra).

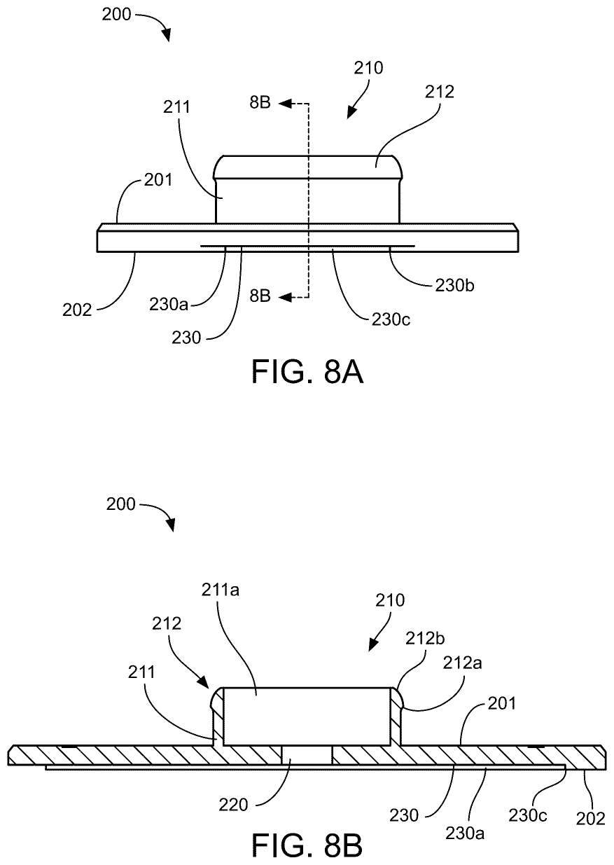

The following description should be taken in view of FIGS. 8A and 8B. Body 211 of stud 210 extends upwardly from external face 201. Annular ring 212 is arranged proximate the terminating end of stud 210, opposite of external face 201. Annular ring 212 includes two edges, lip edge 212a and curved edge 212b, arranged proximate wall 201 and arranged distally in relation to wall 201, respectively. Curved edge 212b of annular ring 212 is arranged to have a curved shaped. Lip edge 212a of annular ring 212 is arranged to have a lip, or a substantially defined edge. Mounting aperture 220 is preferably arranged in a central location relative to internal surface 211a of body 211.

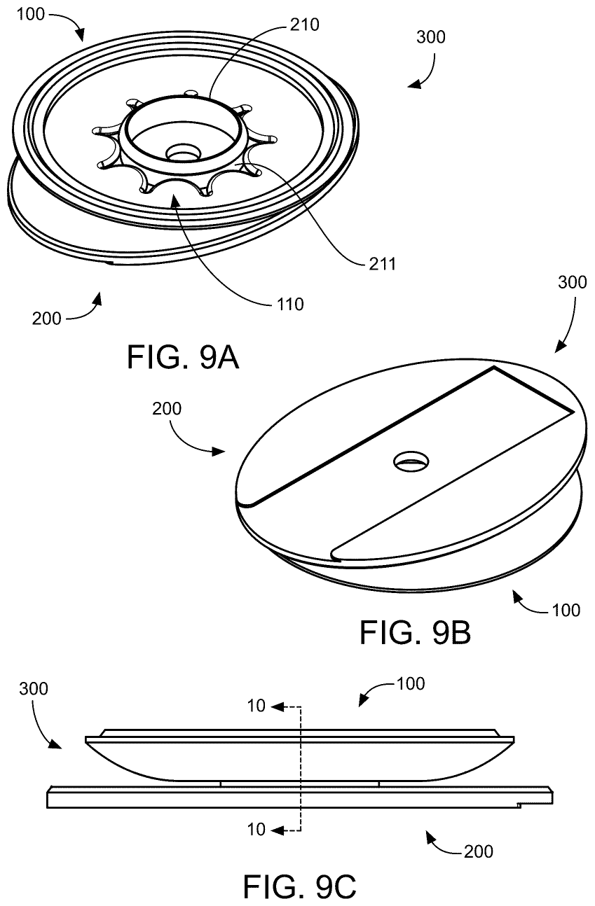

The following description should be taken in view of FIGS. 9A through 9C, which illustrate mounting assembly 300. Mounting assembly 300 comprises star socket 100 and stud plate 200, where stud 210 is removably secured within star aperture 110 via plurality of tabs 120. Plurality of tabs 120 are arranged to abut the external surface of body 211 of stud 210 when mounting plate 200 is engaged to star socket 100.

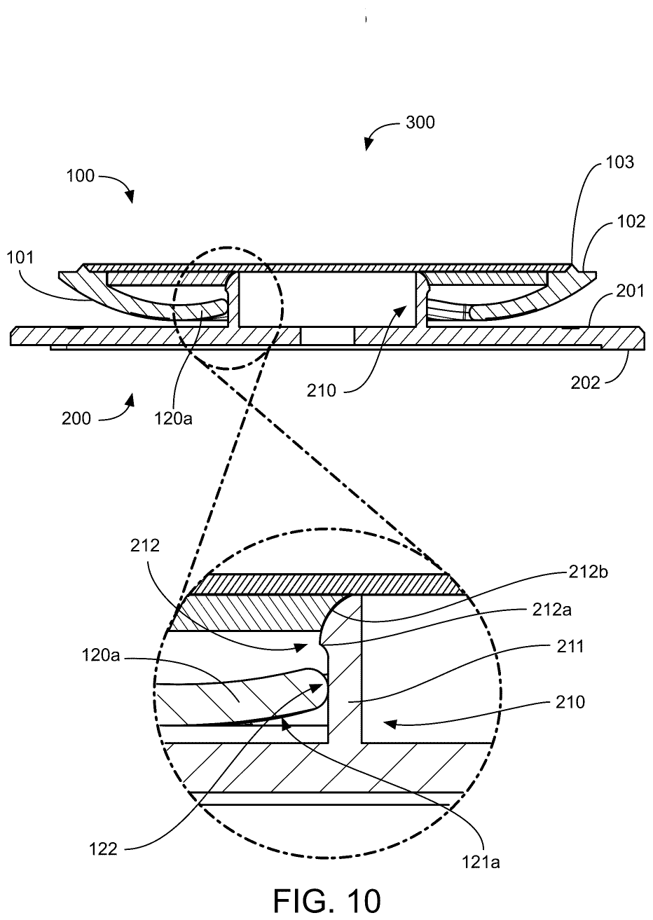

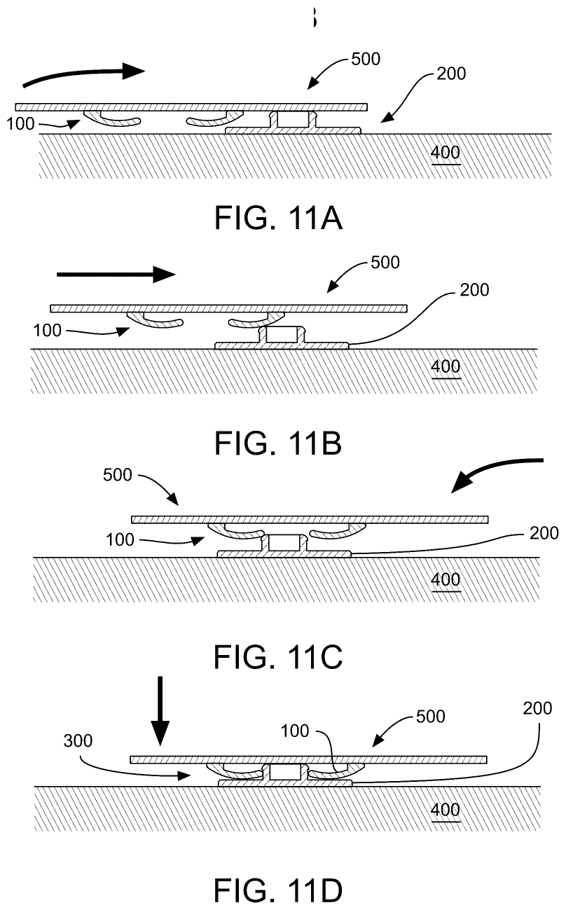

FIG. 10 is a cross sectional view of mounting assembly 300 taken generally along line 10-10 shown in FIG. 9C. FIG. 10 also illustrates a detailed view of stud 210 of stud plate 200 engaged within star aperture 110 of star socket 100. The following description should be taken in view of all of the aforementioned drawings. It should be noted that the description of tab 120a of plurality of tabs 120 (shown in the aforementioned drawings) applies to each tab of plurality of tabs 120. When tab 120a engages stud 210 of stud plate 200, rounded end 122a of tab 120a contacts the outer surface of body 211 of stud 210. To engage tab 120a with stud 210, tab 120a is forcibly pressed over annular ring 212 of stud 210, causing contoured section 121a of tab 120a to flex until rounded end 122a passes over curved edge 212b of annular ring 212. Once rounded end 122a of tab 120a has passed over curved edge 212b of annular ring 212, contoured section 121a of tab 120a partially unflexes such that round end 122a then abuts the surface of body 211 of stud 210. It should be appreciated that contoured section 121a of tab 120a still applies a slight force of flexion to rounded end 122a onto body 211 of stud 210, to maintain a frictional securement (of each of the tabs of plurality of tabs 120) thereon. Lip edge 212a provides a body of interference such that greater force is needed to pull rounded edge 122a of tab 120a past lip edge 212a, to disengage tab 120a from stud 210.

The force and flexion of contoured section 121a of tab 120a that is needed to pull rounded edge 122a past lip edge 212a of annular ring 212 of stud 210 is greater than the force and flexion of contoured section 121a of tab 120a that is needed to push rounded edge 122a past curved edge 212b of annular ring 212 of stud 210. It can be said that the force needed to engage star socket 100 to stud plate 200 is less than the force needed to disengage star socket 100 from stud plate 200.

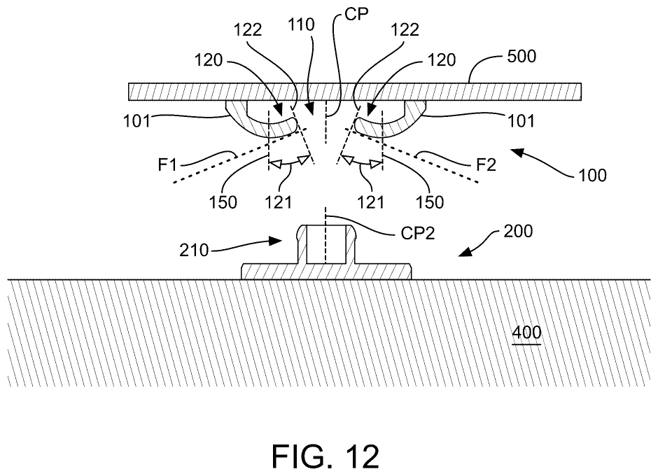

The following description should be taken in view of FIGS. 5A-12. FIGS. 11A through 12 illustrate a cross-sectional view of whiteboard 500 with star socket 100 secured thereto and wall 400 with stud plate 200 secured thereto. FIGS. 11A through 11D illustrate the mounting of star socket 100 and stud plate 200, while FIG. 12 illustrates the configuration of the self-centering aspect of star socket 100.

Once stud plate 200 has been affixed to wall 400, shown and discussed in more detail infra, whiteboard 500 with star socket 100 affixed thereon, may be positioned for engaging mounting assembly 300 (i.e., when stud plate 200 is engaged with star socket 100). Whiteboard 500 and star socket 100 are moved in a direction towards stud plate 200 as shown in FIG. 11A, until contoured face 101 of star socket 100 contacts stud 210 of stud plate 200.

Once contoured face 101 of star socket 100 contacts stud 210 of stud plate, the combination of the slope of contoured face 101 and curved edge 212b of annular ring 212, allow a user to slide contoured face 101 towards the distal end of stud 210, as shown in FIG. 11B.

Then, contoured section 121 of each tab of plurality of tabs 120 allows a user to slide whiteboard 500 and star socket 100 until stud 210 is positioned in a substantially central area abutting each contoured section 121 of each tab of plurality of tabs 120, right above star aperture 110 of star socket 100, as illustrated in FIG. 11C.

A user then can apply pressure to whiteboard 500 to forcibly insert stud 210 within star aperture 110 of star socket 100 to connect star socket 100 to stud plate 200 as shown in FIG. 11D. In other words, a user can apply pressure to whiteboard 500, which flexes contoured section 121 of plurality of tabs 120 to push each rounded end 122 of each tab of plurality of tabs 120 past curved edge 212b of annual ring 211 of stud 210, as described in view of FIG. 10, supra.

FIG. 12 illustrates a cross-sectional view of star socket 100 affixed to whiteboard 500 and stud plate 200 affixed to wall 400. Contoured section 121 of each tab of plurality of tabs 120 is shown to create a funneling (centering) configuration via the curvature of contoured section 121 of each tab of plurality of tabs 120, illustrated by F1 and F2, which guides stud 210 of stud plate 200 into aperture 110 when whiteboard 500 is arranged to be mounted. Funneling configuration F1 and F2 is arranged to allow center point CP of star socket 100 and center point CP2 of stud plate 200 to be colinearly aligned when stud 210 is engaged within aperture 110. Funneling configuration F1 and F2 allows star socket 100 to have a self-centering function on stud 210. Specifically, the funneling configuration F1 and F2 of contoured section 121 allows a user to move stud 210 along contoured face 101 until stud 210 enters the funneling configuration F1 and F2—to mount whiteboard 500 on a mounted stud plate 200 without seeing stud plate 200 mounted on wall 400—by applying pressure on whiteboard 500 to push stud 210 within star socket 100 once stud 210 enters funneling configuration F1 and F2. Funneling configuration F1 and F2 is provided by the curvature of contoured section 121 of each tab of plurality of tabs 120, where that curvature is configured in a direction towards aperture 110 and towards mounted whiteboard 500.

The following description should be taken in view of FIGS. 13A and 13B. FIG. 13A illustrates whiteboard 500 mounted to wall 400. Specifically, FIG. 13A shows mounting assembly 300 (engaged star socket 100 and stud plate 200), where mounting screw 310 can be scen within wall 400. FIG. 13B is a cross-sectional view of FIG. 13A taken along lines 13B-13B in FIG. 13A. Mounting screw 310 is threaded through mounting aperture 220 of stud plate 200 into wall 400, threadably securing stud plate 200 to a surface of wall 400. It should be appreciated that mounting screw 310 is threaded through mounting aperture 220 and into wall 400 before star socket 100 is engaged to stud plate 200, as an engaged whiteboard 500 to star socket 100 blocks access to mounting screw 310.

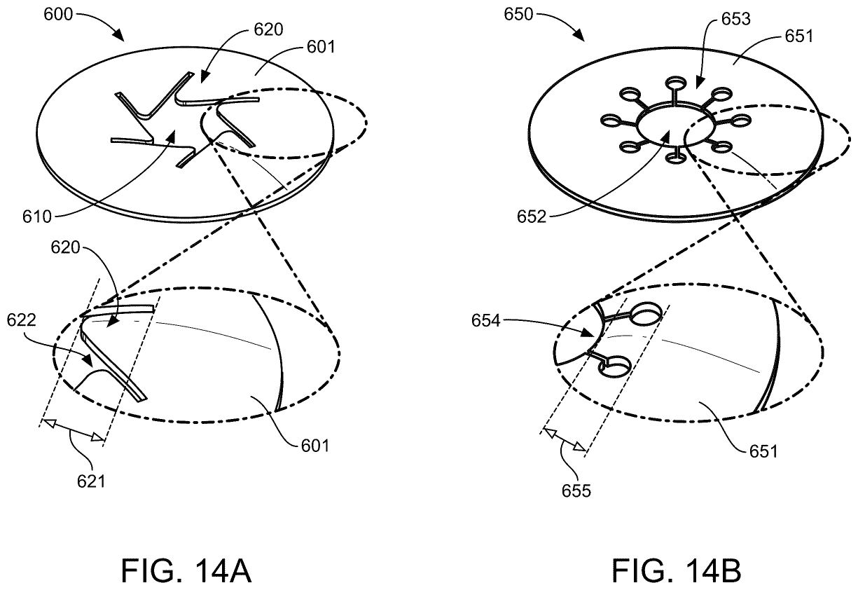

FIG. 14A illustrates a perspective view of a first alternative embodiment of the star socket, star socket 600. As shown in the drawings, the number of tabs of plurality of tabs 620, may be less than plurality of tabs 120 of star socket 100 (shown in the aforementioned drawings). Star socket 600 comprises generally the same features as star socket 100, described supra. Specifically, star socket 600 includes contoured face 601, which terminates at contoured section 621 of each tab of plurality of tabs 620. Contoured section 621 terminates at each respective rounded end 622 of each tab of each tab of plurality of tabs 620. The collective rounded ends 622 of each tab of each tab of plurality of tabs 620 circumscribe star aperture 610.

FIG. 14B illustrates a perspective view of a second alternative embodiment of the star socket, star socket 620. Star socket 650 comprises generally the same features as star socket 100, described supra. Specifically, star socket 650 includes contoured face 651, which terminates at contoured section 655 of each tab of plurality of tabs 653. Contoured section 655 terminates at each respective end 654 of each tab of each tab of plurality of tabs 653. It should be appreciated that a notable difference between star sockets 100 and 600, and star socket 650, is each respective end 654 of each tab of each tab of plurality of tabs 653 of star socket 650 have an inversely oriented end 654, that is, ends 122 and 622, of star sockets 100 and 600 have a configuration that would appear to resemble a convex curvature, or outwardly arranged curve when viewed from above apertures 110 and 610, respectively (relative to the external perimeters of sockets 100 and 600), whereas end 654 of each tab of each tab of plurality of tabs 653 have a configuration that would appear to resemble a concave curvature, or inwardly arranged curve when view from above aperture 652 (relative to the external perimeter of socket 653). The collective ends 654 of each tab of each tab of plurality of tabs 653 circumscribe star aperture 652.

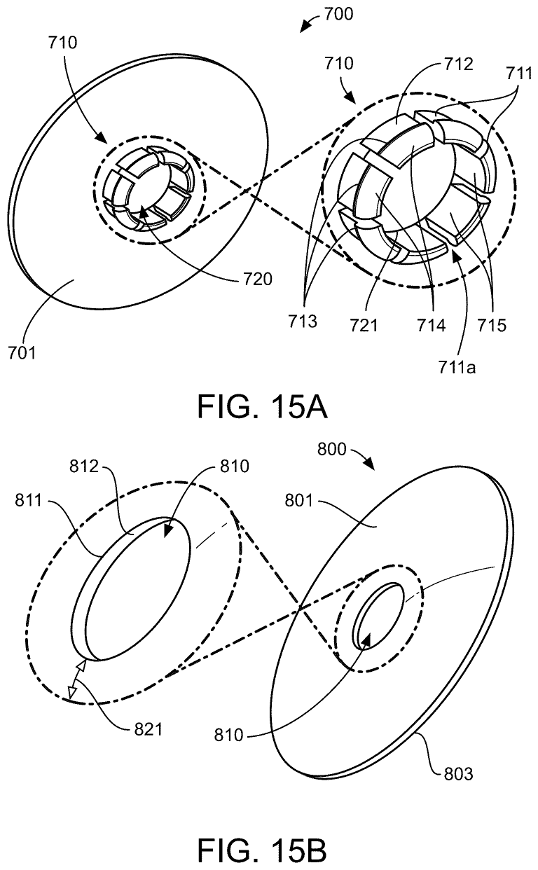

The following description should be taken in view of FIG. 15A and 15B. FIG. 15A is a perspective view of a first alternative embodiment of stud plate 100, stud plate 700, which shows a detailed perspective view of stud 710. FIG. 15B is a perspective view of a third alternative embodiment of star socket 100, star socket 800, which shows a detailed view of contoured section 821 and aperture 810. It should be noted that both stud plate 700 and socket 800 are configured to be used in conjunction with an alternative embodiment of the mounting assembly of the present invention, whereas stud plate 700 includes dynamic stud 710 and socket 800 includes fixed aperture 810. Unlike star socket 100 and stud plate 200, described supra, where star socket 100 includes a plurality of tabs that are configured to flex to create frictional tension around an engaged stud of stud plate 200, socket 800 does not comprise a plurality of tabs that circumscribe aperture 810. Inversely, dynamic stud 710 of stud plate includes a plurality of protrusions that circumscribe aperture 720 which are arranged to flex to allow dynamic stud 720 to be inserted within aperture 810 when mounting the present invention, while dynamic stud 720 imparts force on rim 822 of aperture 810 to maintain its respective position within aperture 810.

Stud plate 700 comprises external face 701 that is arranged to extend from a base arranged on the opposite side of stud plate 700, mounting aperture 720 which is arranged at a substantially central location on external face 701, and dynamic stud 710 which is arranged to circumscribe mounting aperture 720 and extend from external face 701. Stud 710 comprises plurality of protrusions 711 which circumscribe aperture 720. Plurality of protrusions 711 are preferrable uniformly spaced around outer perimeter 721 of aperture 720, creating plurality of channels 711a. Each individual protrusion of plurality of protrusions 711 includes body 712, lip 713 which extends outwardly from the external surface of body 712, and rounded end 714 which defines the terminating end of each individual protrusion of plurality of protrusions 711. Rounded end 714 is arranged to curve from terminating end of internal surface 715 of body 712 until rounded end 714 meets lip 713. The internal surface 715 of body 712 of each individual protrusion of plurality of protrusions 711 extends from outer perimeter 721 of aperture 720.

Star socket 800 is a rigid socket embodiment of star socket 100, that is, socket 800 docs not have a plurality of tabs that circumscribe aperture 810. Star socket 800 comprises contoured face 801 which extends from base 803, having a contour that is curved away from a mounting face (not shown-mounting face is arranged on the surface opposite of contoured face 801). The contour of contoured face 801 terminates at contoured section 821, which has a contoured that curved towards base 803, that is, contoured section 821 has a contour arranged in a direction opposite that of contoured face 801. Contoured section 821 terminates at outer perimeter 811 of aperture 810.

Body 712 of each individual protrusion of plurality of protrusions 711 is semi-flexible, such that rounded ends 714 of stud 710 is pressed into aperture 810 of star socket 800, each individual protrusion of plurality of protrusions 711 will flex inwardly towards the center point of aperture 720 of stud plate 700 until the outer surface of each body 712 of each individual protrusion of plurality of protrusions 711 is contacting internal surface 812 of aperture 810 of star socket 800 which unflexes each body 712 of each individual protrusion of plurality of protrusions 711, but not entirely, to maintain tension on internal surface 812 of aperture 810, to keep stud 710 within aperture 810. Only a forcible removal, e.g., via pulling, will disengage stud 710 from within aperture 810.

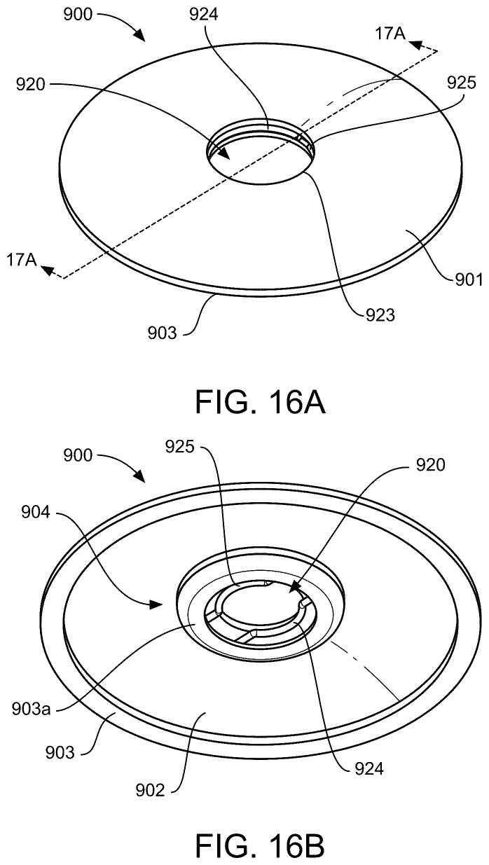

The following description should be taken in view of FIGS. 16A and 16B. FIG. 16A is a perspective view of a fourth alternative embodiment of star socket 100, star socket 900. FIG. 16B is a bottom perspective view of a fourth alternative embodiment of star socket 100, star socket 900. Like star socket 800, described supra and shown in FIG. 15B, star socket 900 lacks tabs and aperture 920 is fixed. Star socket 900 includes contoured face 901 that extends from base 903. Contoured face 901 has a configuration that is substantially identical to contoured face 101, described supra, but does not terminate at a plurality of tabs, but rather terminates at outer perimeter 923 of aperture 920. Aperture 920 is arranged in a substantially central location on contoured face 901. Extending from internal surface 902 is aperture body 904. Aperture body 904 has aperture body base 903a, which may be alternatively configured to have a colinear surface with basc 903. Housed within aperture body 904 are tension wires 924 and 925 which collectively define an inner circumference that is preferably less than the inner circumference of outer perimeter 923 of aperture 920. Tension wires 924 and 925 are arranged to create interference against the annular ring of the stud plate, described supra, when the stud is inserted within aperture 920, where tension wires 924 and 925 will then impart force onto the outer surface of the body of the stud of the stud plate.

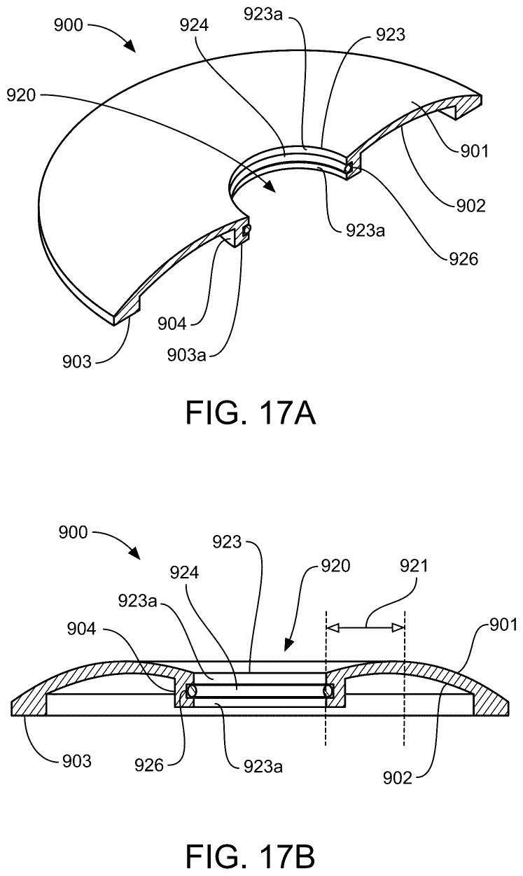

The following description should be taken in view of FIGS. 17A and 17B. FIG. 17A is a cross-sectional view of star socket 900 taken generally along line 17A-17A in FIG. 16A and FIG. 17B is a front view of the cross-section of the star socket shown in FIG. 17A. Aperture body 904 includes wire channel 926 which is arranged to fixedly secure tension wires 924 and 925. Wire channel 926 is channel arranged within inner surface 923a of aperture 920. Wire channel 926 is preferably a continuous channel. Star socket 900 also includes contour section 921 of contoured face 901. Contour section 921 is arranged to have a contour that curves in the downward direction towards base 903 and terminates at outer perimeter 923 of aperture 920.

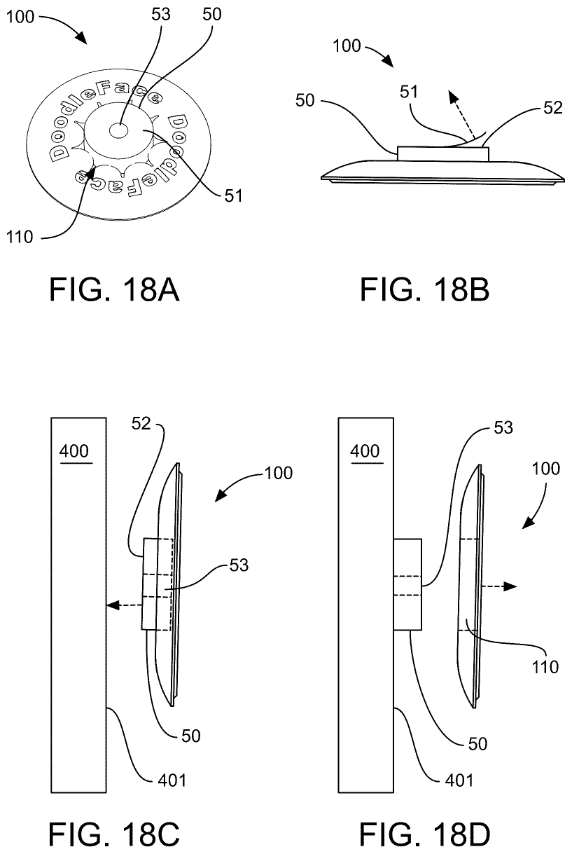

The following description should be taken in view of FIG. 18A and 18B. Star socket 100 is illustrated with screw positioning foam 50 positioned within aperture 110. Screw positioning foam 50 comprises adhesive layer cover 51, adhesive layer 52, and marking aperture 53. Screw positioning foam 50 is arranged to adhere to a structure, such as a wall, and provide a guide point for marking a screw hole to mount a stud plate at a marked position on a wall. To adhere screw positioning foam 50, adhesive release liner 51 is first removed to expose adhesive layer.

The following description should be taken in view of FIGS. 18B-18D. To adhere screw positioning foam 50, adhesive release liner 51 is first removed to expose adhesive layer 52, as illustrated in FIG. 18B. Then, with adhesive layer 52 facing planar face 401 of wall 400, star socket 100 is moved such that adhesive layer 52 of screw positioning foam 50 will adhere to planar face 401, as illustrated in FIG. 18C. Lastly, star socket 100 is pulled away from planar face 401 of wall 400, which will pull screw positioning foam 50 from within aperture 110 of star socket 100. A user then may use marking aperture 53 to make a marking on planar face 401 of wall 400 to designate where a mounting screw with mounting aperture of stud plate should be threaded into wall 400. A user then may remove screw positioning foam 50 from planar face 401 of wall 400 to reveal the mark made via the guide provided by marking aperture 53.

The following description should be taken in view of all the drawings and their respective descriptions, supra. It should be appreciated that star sockets 600 and 650 have a funneling configuration of their respective contoured sections, 621 and 655 of each tab of plurality of tabs 620 and 653, respectively—which both function in the manner described in view of FIG. 12 for star socket 100. It should also be appreciated that star sockets 800 and 900 have a funneling configuration of their respective contoured sections, 821 and 921 of contoured faces 801 and 901, respectively-which both function in the manner described in view of FIG. 12 for star socket 100, without the configuration of a plurality of tabs.

It should be noted that when stud 210 (or its alternative embodiments) is positioned within aperture 110 (or its alternative embodiments), that stud 210 may rotate within aperture 110 to position whiteboard 500 that is affixed to stud plate 200 to a particular angle. It should also be noted that stud 210 may be tilted slightly within aperture 110 to accommodate stud plates that may not be perfectly aligned with their respective star sockets on a whiteboard, or to accommodate irregularities on the selected wall. When stud 210 is engaged within aperture 110, there is an approximate five degrees of bend tolerance of star socket 100 before imparting sufficient force to remove stud 210 from aperture 110.

Substrate 10 of whiteboard 500 may be made of porcelain-or enamel coated plastic, aluminum or hard coated durable films laminated onto the rigid surface of substrate. Substrate 10 may be made of laminated chipboard, high-pressure laminates or steel boards with a matte-finished or glossy white, polyester or acrylic, coating. In a preferred embodiment, substrate 10 of whiteboard 500 is made of a material that allows for a semi-flexibility while maintaining a rigid form for removal from a mounted position. Substrate 10 in a preferred embodiment has an approximate thickness of 0.08″, where substrate 10 is still rigid enough to maintain shape when supported at select mounting assembly points. Substrate 10, in a preferred embodiment, is of a construction that is flexible enough to bend. The bending allows reduced overall weight of substrate 10, deflection instead of snapping when force is exerted on substrate 10, flexion when substrate 10 is pulled away from an engaged mounting assembly, i.e., when star socket 100 is disengaged from stud plate 10, and conformity to irregularities on wall 400 or misaligned mounting assemblies when two or more mounting assemblies are used.

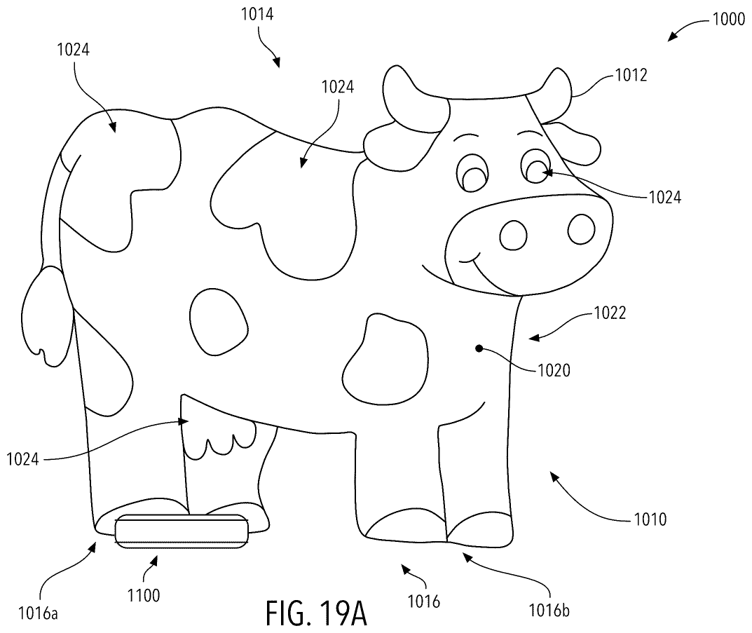

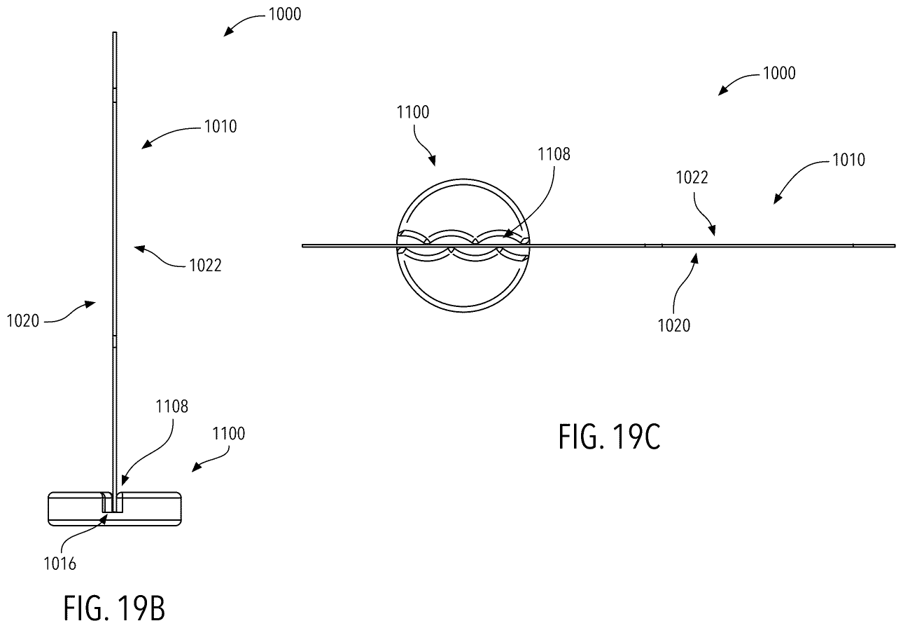

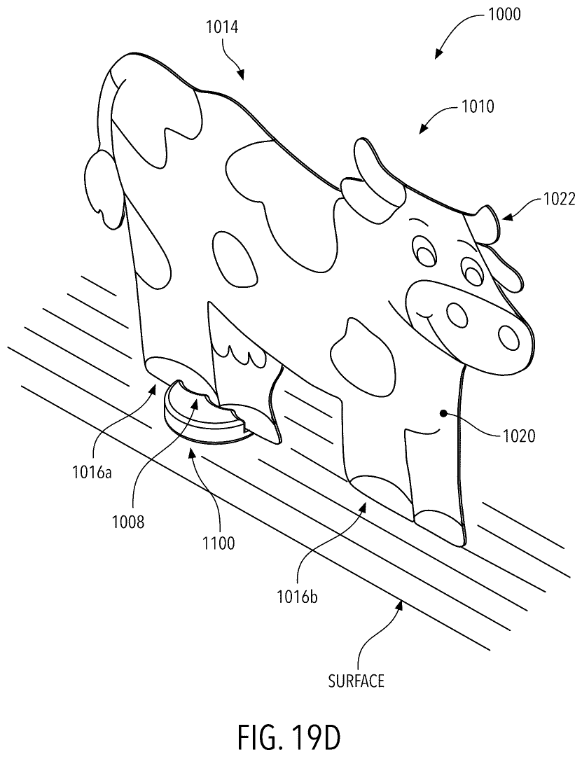

Adverting now to FIGS. 19A through 31B which disclose the character display system of the present invention. The semi-flexible substrate described infra, may be substantially identical to semi-flexible substrate 10 that forms whiteboard 500, as described with reference to FIGS. 1A through 3, less structural modifications to accommodate base component 1100 for upright orientation. The following description will focus primarily on aspects of the invention that represent a system that allows one or more of whiteboard 500 (including 500a-500f) or semi-flexible substrate 1010, to be used with at least one base component for upright orientation. As such, it should be appreciated that whiteboard 500 (including 500a-500f) can be modified to engage with the at least one base component, or other modifications such as a stabilizing contour, and a texturized surface that enhance the use of the crayons.

FIG. 19A illustrates character display system 1000 of the present invention. Character display system 1000 comprises a play character and base 1100. The play character comprises semi-flexible substrate 1010 with design face 1020 and outer edge 1012 of semi-flexible substrate 1010 forms a design outline. Design face 1020 comprises printed indicia 1024 forming internal design on semi-flexible substrate 1010, and the internal design and the design outline form a first character. As shown in FIGS. 2 and 3, design face 1020 may have outer border 20 or plurality of lines of demarcation that are arranged to define a plurality of closed shapes having fill color that is color of semi-flexible substrate 1010. As such, it should be appreciated that printed indicia 1024 is intended to mean one or more of outer border 20 or plurality of lines of demarcation. Thus, outer edge 1012 of semi-flexible substrate 1010 defines the shape of the play character and printed indicia 1024 completes the play character with its various details. Semi-flexible substrate 1010 has top 1014 and bottom 1016. Bottom 1016 includes bottom section 1016a and bottom section 1016b, where one or more of the bottom sections may be removably engaged to base 1100 of system 1000.

It is contemplated that the play character can take the form of various representational and non-representational objects, including but not limited to animals, human figures, vehicles, buildings, or abstract shapes. Likewise, printed indicia 1024 may take the form of various shapes, patterns, colors, and textures to enhance the visual appeal and customizability of design face 1020.

FIGS. 19B and 19C provide a side and top view, respectively, of character display system 1000. These figures illustrate semi-flexible substrate 1010, design face 1020, and rear face 1022. Base 1100, further comprising retention slot 1108, is removably coupled to bottom 1016 of semi-flexible substrate 1010. FIG. 19D is a perspective view of character display system 1000 resting on a surface. Bottom section 1016a and bottom section 1016b are shown, where base 1100 comprises contoured retention slot 1008.

In general, FIGS. 19A through 19D illustrate character display system 1000 as comprising a semi-flexible play character with a design face and a stabilizing contour along its bottom edge, and base 1100 with a retention slot 1108 configured to support the play character in an upright position.

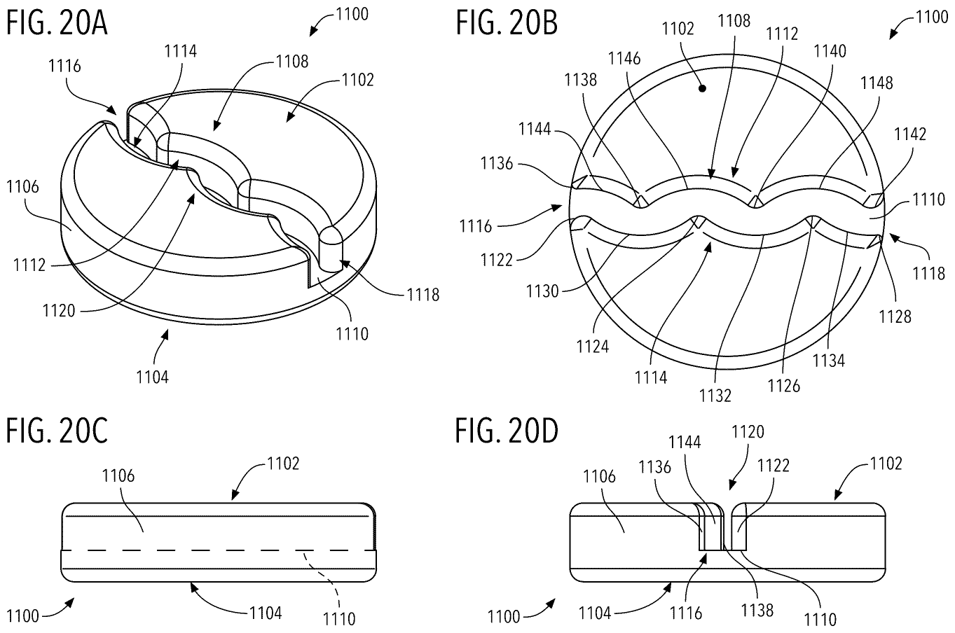

FIGS. 20A through 20D illustrate base 1100 in more detail.

FIG. 20A is a perspective view of base 1100, comprising top 1102, bottom 1104, outer wall 1106, and contoured retention slot 1108 being disposed within top 1102. Contoured retention slot 1108 is defined in part by first retention wall 1112, second retention wall 1114, first side opening 1116, second side opening 1118, top opening 1120 and floor 1110.

FIG. 20B is a top view of base 1100. This view illustrates top 1102 and contoured retention slot 1108. Contoured retention slot 1108 is defined in part by first retention wall 1112, second retention wall 1114, first side opening 1116, second side opening 1118, and top opening 1120. Second retention wall 1114 comprises first node 1122, second node 1124, third node 1126, fourth node 1128, first depression 1130, second depression 1132, third depression 1134. First retention wall 1112 comprises fifth node 1136, sixth node 1138, seventh node 1140, eighth node 1142, fourth depression 1144, fifth depression 1146, and sixth depression 1148. A first plurality of contact nodes, including fifth node 1136, sixth node 1138, seventh node 1140, and eighth node 1142, may extend at different lengths from first retention wall 1112 towards second retention wall 1114. A second plurality of nodes, including first node 1122, second node 1124, third node 1126 and fourth node 1128, may extend at different lengths from second retention wall 1114 towards first retention wall 1112. In a preferred embodiment, the inner most nodes of the first and second retention walls are preferably substantially colincar, e.g., sixth node 1138 and seventh node 1140 are colinear, second node 1124 and third node 1126 are colincar.

FIG. 20C is a side view of base 1100, illustrating top 1102, bottom 1104, and outer wall 1106. Floor 1110 of contoured retention slot 1108 is shown as a hidden line, positioned proximate to bottom 1104, indicating that retention slot 1108 extends more than halfway through top 1102.

FIG. 20D is a front view of base 1100, illustrating top 1102, bottom 1104, outer wall 1106, and contoured retention slot 1108 with floor 1110. FIG. 20D illustrates first side opening 1116 which is bounded by first node 1122 and fifth node 1136 (and it should be noted that the second side opening is bounded by the fourth and eighth nodes). As described supra, the various extension lengths of the first and second plurality of nodes are demonstrated, e.g., sixth node 1138 extends farther than fifth node 1136, which makes depression 1144 of the first retention wall of retention slot 1108 visible from first side opening 1116.

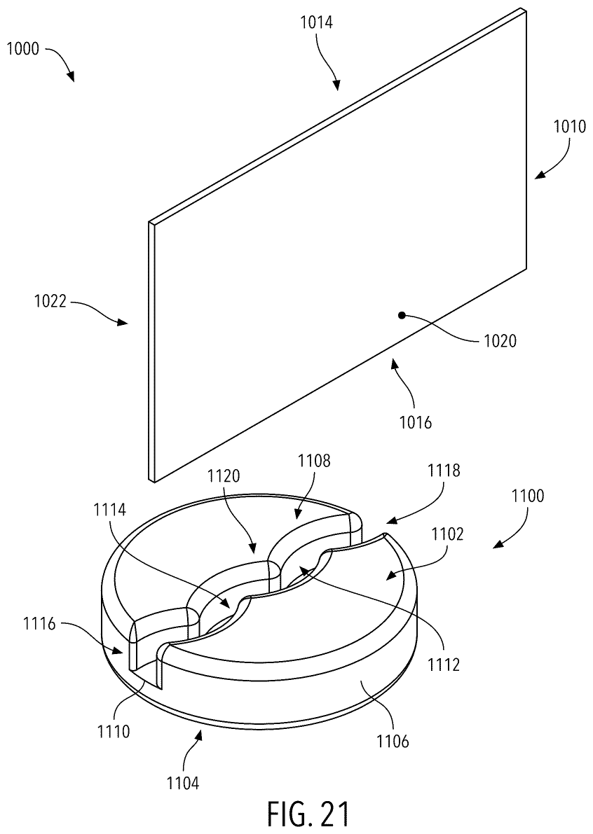

FIGS. 21 through 23 illustrate the interaction between base 1100 and semi-flexible substrate 1010. In these figures, semi-flexible substrate 1010 is shown only in a representative rectangular form for illustrative purposes, it being understood that the shape of semi-flexible substrate 1010 may vary greatly while still functioning within the described character display system 1000.

FIG. 21 is an exploded view of character display system 1000 that illustrates semi-flexible substrate 1010, design face 1020, rear face 1022, base 1100, top 1102, bottom 1104, outer wall 1106, and contoured retention slot 1108, and floor 1110.

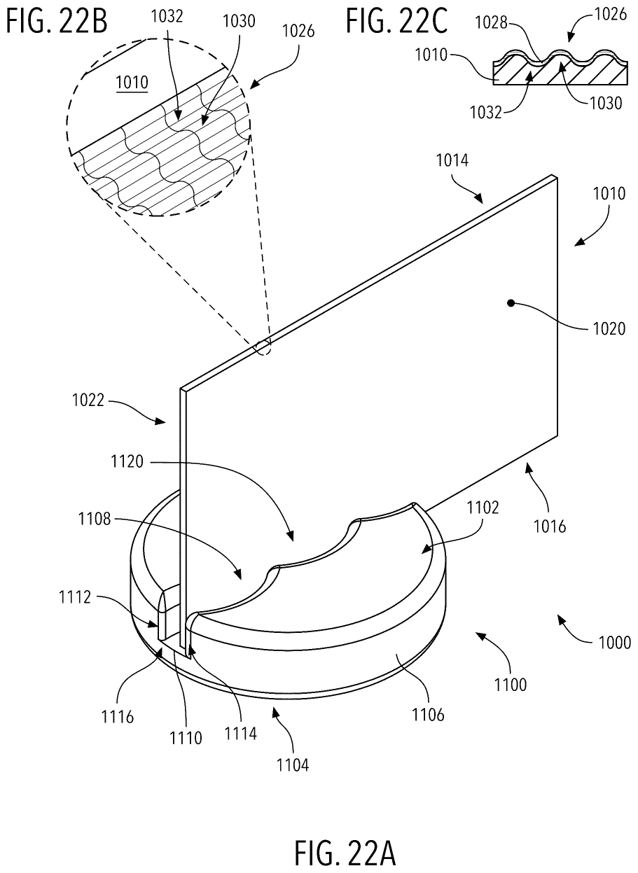

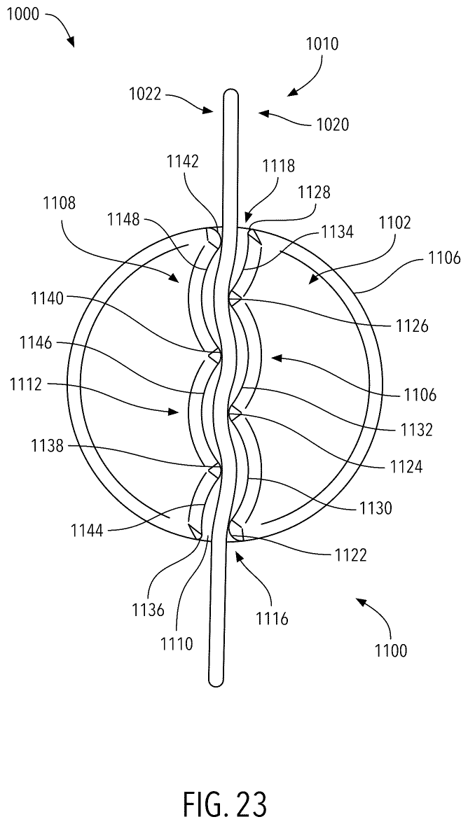

FIGS. 22A and 23, a perspective view and a top view respectively, of character display system 1000, show semi-flexible substrate 1010 inserted into contoured retention slot 1108 of base 1100. When semi-flexible substrate 1010 is fully inserted into contoured retention slot 1108, first retention wall 1112 and second retention wall 1114 are positioned to apply compressive force to semi-flexible substrate 1010. The distance between first retention wall 1112 and second retention wall 1114 is less than the thickness of semi-flexible substrate 1010, causing semi-flexible substrate 1010 to undergo a slight flexural deformation. In other words, the apexes of each of the first plurality of nodes and the apexes of the second plurality of nodes create a distance therebetween and that distance is less than the thickness of semi-flexible substrate 1010. The semi-flexibility of semi-flexible substrate 1010 facilitates this deformation without causing damage to semi-flexible substrate 1010. The strategic placement of a first plurality of nodes (e.g., nodes 1136, 1138, 1140, 1142) and a second plurality of nodes (e.g., nodes 1122, 1124, 1126, 1128) along first retention all 1112 and second retention wall 1114, respectively, creates a series of contact points with the surfaces, e.g., faces 1020 and 1022, of semi-flexible substrate 1010. The varying lengths of the first and second plurality of nodes creates a varying compressive force at each contact point, and a corresponding distribution of flexural deformation along the surface of semi-flexible substrate 1010. This distribution of contact points and varied compressive force, in combination with the semi-flexibility of semi-flexible substrate 1010, generates a reliable frictional force that secures semi-flexible substrate 1010 within retention slot 1108 of base 1100, while still allowing for easy insertion and removal. The configuration of nodes creates a reliable interference fit, preventing unintended dislodgement of semi-flexible substrate 1010 from base 1100, while top opening 1120 facilitates insertion and removal. Preferably, only one node of the pair of nodes (e.g., at least one of nodes 1122 and 1136) of first side opening 1116 and only one node of the pair of nodes (e.g., at least one of nodes 1128 and 1142) of second side opening 1118 contact semi-flexible substrate 1010.

The balance between compressive force, flexural deformation, and frictional force is carefully calibrated to provide both secure retention and case of use. The presence of first depression 1130, second depression 1132, and third depression 1134 on second retention wall 1114, and fourth depression 1144, fifth depression 1146, and sixth depression 1148 on first retention wall 1112 allow the semi-flexible substrate 1010 to flex into these depressions, further optimizing the distribution of force. The nodes that extend from first retention wall 1112 and second retention wall 1114 create small, focused contact points that increase the frictional force while preventing the overall compressive force from becoming too high, ensuring that semi-flexible substrate 1010 is not too difficult to insert into contoured retention slot 1108. The overall design allows a user to easily insert and remove semi-flexible substrate 1010 while ensuring that the play character remains upright and does not casily fall out during play.

In reference to FIGS. 22B and 22C, substrate 1010 comprises texturized surface 1026, which surface incorporates a finely engineered microtexture or “tooth” pattern that enhances substrate 1010 ability to receive and retain dry-erase crayon media. Texturized surface 1026 includes a series of rolling, wave-like elevations and depressions, e.g., rolling mounting undulation 1030 and valley undulation 1032, (as opposed to abrupt or jagged features), and is coated with a conformal dry-erase coating, e.g., dry-erase costing layer 1028. This combination allows for effective crayon adherence and vivid color deposition on substrate 1010, while still preserving the ability to crase marks cleanly using a standard cloth.

Texturized surface 1026 may include a repeating pattern of micro-scale undulations—described as “rolling mountains” rather than “cliffs,” due to a non-pointed configuration. These irregularities, e.g., rolling mounting undulation 1030 and valley undulation 1032, are shallow, curved features that provide sufficient surface area and mechanical friction to grip the pigment particles in dry-erase crayons. Dry-erase coating layer 1028 conforms to undulations 1030, 1032 and retains low surface energy properties, enabling casy erasure despite the presence of texture. This combination results in a dual-function surface of substrate 1010: it accepts and holds pigment from crayons with improved clarity and saturation, and can be erased using a dry or damp cloth without leaving residuc.

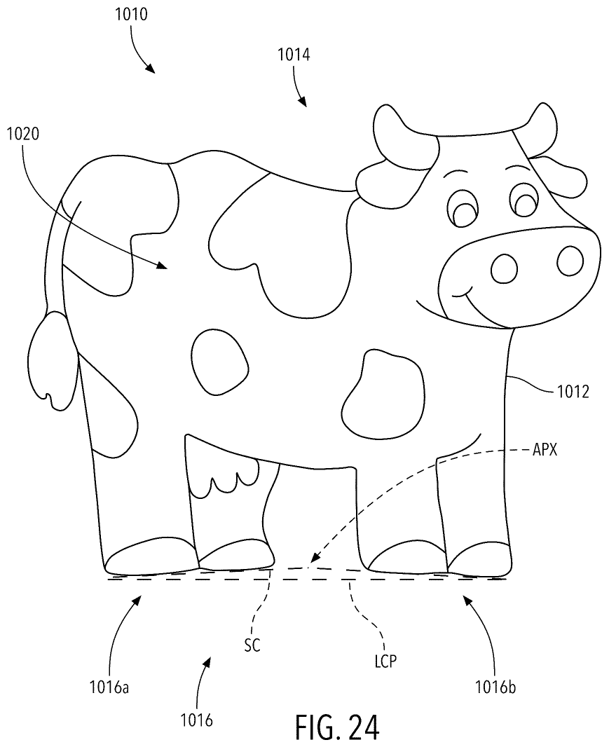

FIG. 24 is a front view of play character formed from semi-flexible substrate 1010. Play character has top 1014 and bottom 1016. Design face 1020 is shown, though it may also be disposed on the opposing rear face (not shown), i.c., each of the respective faces may have printed indicia forming at least one play character (e.g., one or two play characters per substrate). Bottom 1016 comprises bottom section 1016a and bottom section 1016b, each of which is positioned at opposing ends of play character and represent the lowest points of bottom 1016 along edge 1012. Stabilizing contour SC is shown and extends from lowest contact point LCP of respective bottom sections 1016a and 1016b to apex APX. Lowest contact point LCP is the point where bottom sections 1016a and 1016b would contact a surface when base 1100 is not in usc.

Stabilizing contour SC provides a non-linear bottom edge for the play character and is configured to extend from lowest bottom corners upward to apex APX, which may be at a middle point between bottom section 1016a and bottom section 1016b. This means that both of bottom sections 1016a and 1016b are arranged to be non-parallel with a respective surface, either angled and/or curved. Thus, the respective outer edge 1012 of each of bottom sections 1016a and 1016b are portions of the overall arch of stabilizing contour SC. Stabilizing contour SC ensures stability during play by maintaining planar contact equilibrium with the play surface.

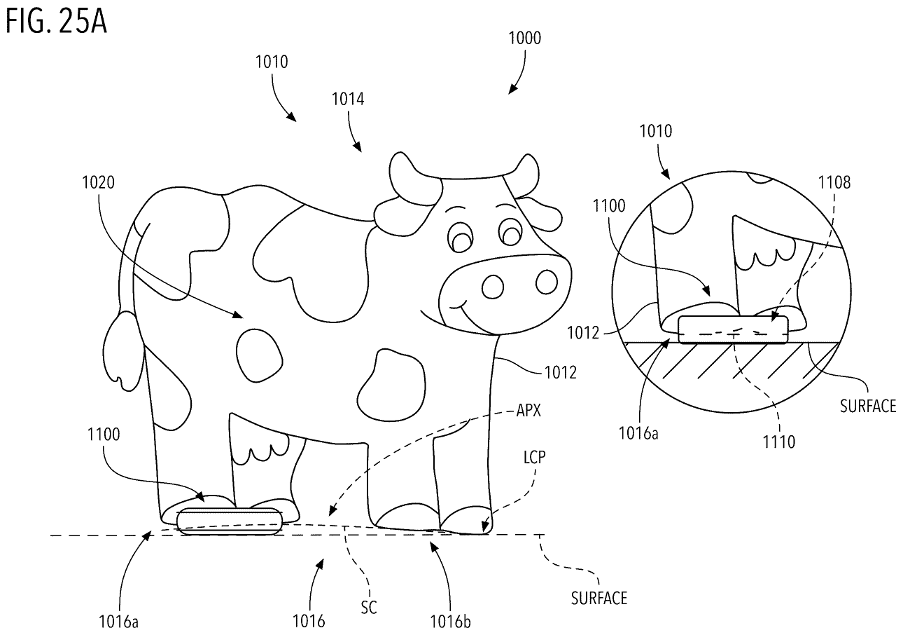

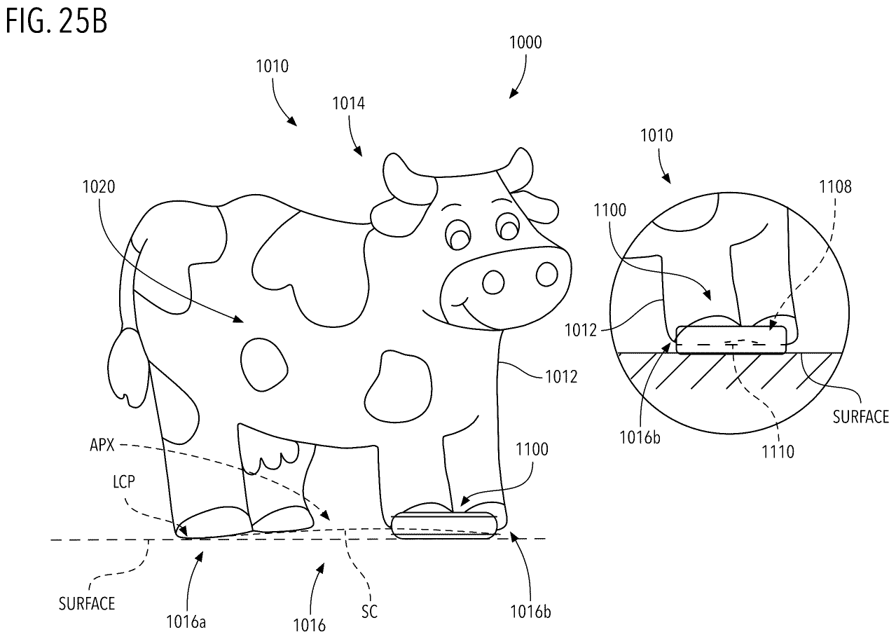

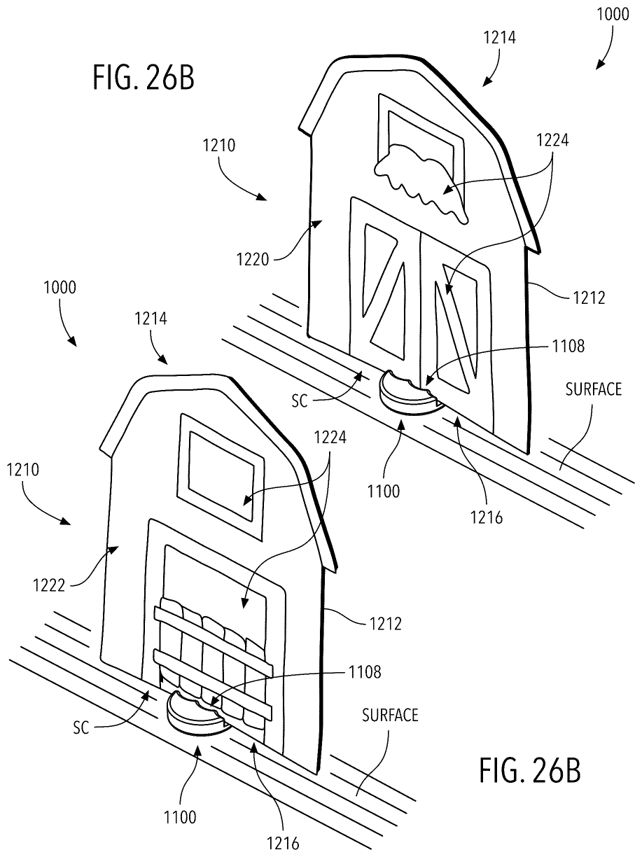

FIGS. 25A through 30B, presented below, will further illustrate the stabilizing contour feature and its function in maintaining stability, particularly in comparison to configurations lacking such a contour and the issues presented with its omission. It is important to note that the stabilizing contour feature can be simply described as an arcuate edge of the bottom portion of the outer edge of the substrate, whether a single, uninterrupted edge (e.g., FIGS. 26A-26B and 28A-29C), or multiple bottom sections having a space therebetween (e.g., FIGS. 19A-19D, 24-25B) and each of the bottom sections comprising a portion of the total are of the stabilizing contour.

FIGS. 25A and 25B illustrate character display system 1000 resting on a surface. Semi-flexible substrate 1010 comprises design face 1020 and has top 1014 and bottom 1016. Bottom 1016 includes bottom section 1016a and bottom section 1016b. Stabilizing contour SC extends from lowest contact point LCP of respective bottom sections 1016a and 1016b to apex APX. Base 1100, further comprising retention slot 1108, is coupled to either bottom section 1016a (FIG. 25A) or bottom section 1016b (FIG. 25B). To allow the figures to rest on an even surface, the base 1100 has a floor 1110. Outer edge 1012 is shown.

When semi-flexible substrate 1010 is inserted within contoured retention slot 1108 of base 1100, stabilizing contour SC enables the play character to maintain planar contact equilibrium with the support surface, regardless of which bottom section (1016a or 1016b) the base 1100 is coupled to.

Stabilizing contour SC provides a non-linear bottom edge for the play character and is configured to extend from lowest bottom corners upward to apex APX, which may be at a middle point between bottom section 1016a and bottom section 1016b along the are of stabilizing contour SC, or simply a middle point along an uninterrupted bottom edge that is configured with a stabilizing contour. Stabilizing contour SC ensures stability during play by maintaining planar contact equilibrium with the play surface. In this context, “planar contact equilibrium” means that a stable portion of bottom 1016 is in contact with the surface, preventing the play character from casily tipping or falling over.

FIGS. 25A through 30B, presented below, will further illustrate the stabilizing contour feature and its function in maintaining stability, particularly in comparison to configurations lacking such a contour.

FIGS. 25A and 25B illustrate character display system 1000 resting on a surface. Semi-flexible substrate 1010 comprises design face 1020 and has top 1014 and bottom 1016. Bottom 1016 includes bottom section 1016a and bottom section 1016b. Stabilizing contour SC extends from lowest contact point LCP of respective bottom sections 1016a and 1016b to apex APX. Base 1100, further comprising retention slot 1108, is coupled to either bottom section 1016a (FIG. 25A) or bottom section 1016b (FIG. 25B). To allow the figures to rest on an even surface, the base 1100 has a floor 1110, which allows the stabilizing contour SC of the portion within contoured retaining slot 1108 to make the most contact with floor 1110, thereby enhancing stability in the upright position.

When semi-flexible substrate 1010 is inserted within contoured retention slot 1108 of base 1100, stabilizing contour SC enables the play character to maintain planar contact equilibrium with the support surface, regardless of which bottom section (1016a or 1016b) the base 1100 is coupled to.

FIGS. 26A and 26B illustrate character display system 1000 and a second play character. The second play character comprises semi-flexible substrate 1210 with design face 1220 and rear face 1222. Design face 1220 comprises indicia 1224. Rear face 1222 comprises indicia 1224, which may be different or the same as indicia 1224 on design face 1220. Semi-flexible substrate 1210 has outer edge 1212 that defines the shape of the play character, i.c., an outline or silhouette. Play character has top 1214 and continuous bottom 1216. Stabilizing contour SC is shown and base 1100, further comprising retention slot 1108, is coupled to continuous bottom 1216.

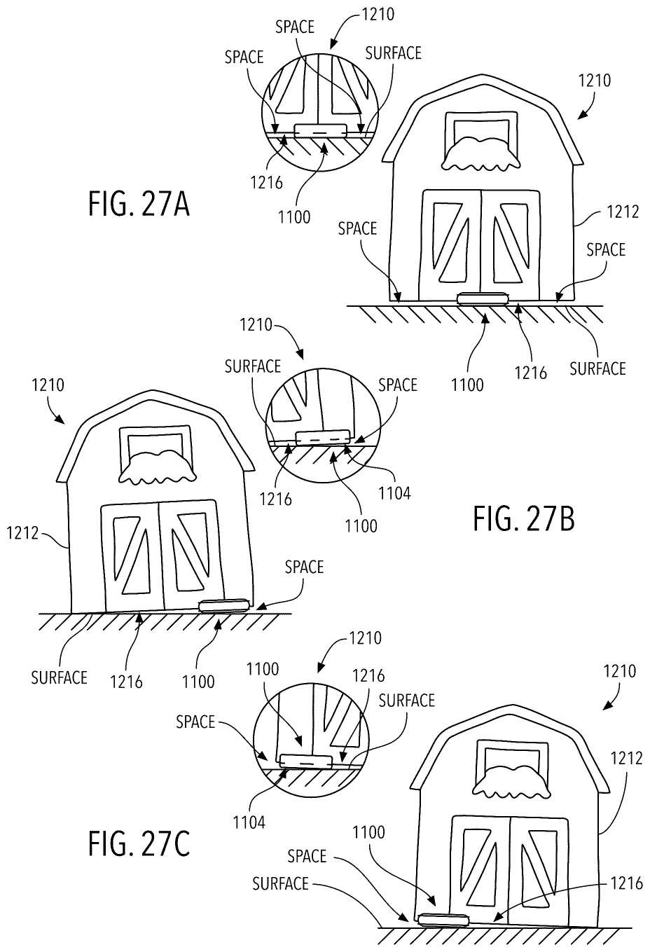

FIGS. 27A, 27B, and 27C illustrate the instability that results from removing the stabilizing contour seen in FIG. 26A and 26B. In these figures, bottom 1216 is linear and lacks a stabilizing contour. In FIG. 27A, with base 1100 coupled to a center portion of continuous bottom 1216, the linear nature of bottom 1216 creates a space between bottom 1216 and the play surface, destabilizing semi-flexible substrate 1210. In FIGS. 27B and 27C, with base 1100 coupled to a side of continuous bottom 1216, space exists between bottom 1104 of base 1100 and the surface, causing base 1100 to tilt, destabilizing semi-flexible substrate 1210.

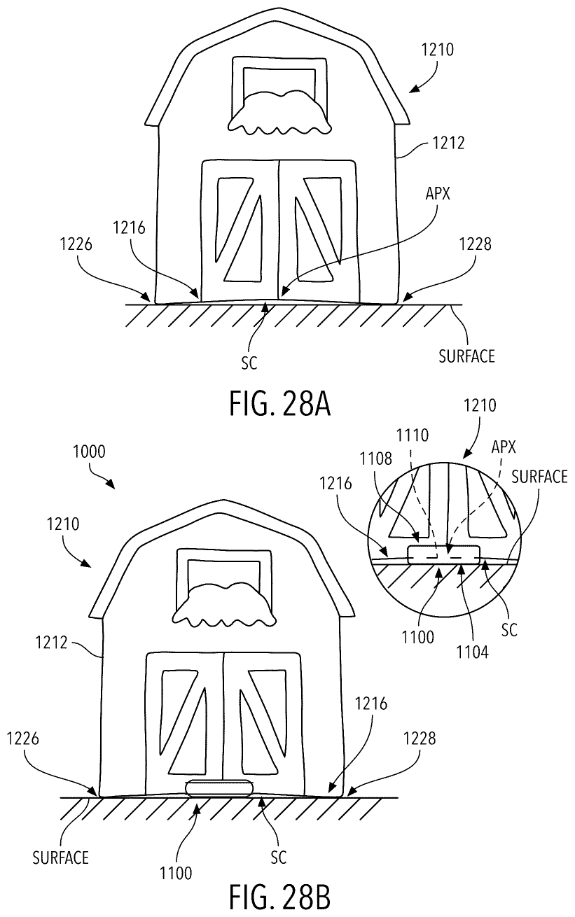

FIGS. 28A and 28B illustrate the reintroduction of stabilizing contour SC to the play character of FIGS. 27A through 27C. FIG. 28A shows semi-flexible substrate 1210 with design face 1220, outer edge 1212, and stabilizing contour SC, as well as apex APX. With stabilizing contour SC, bottom corners 1226 and 1228 of bottom 1216 contact the play surface. FIG. 28B shows that character display system 1000 is now stabilized with base 1100 coupled to semi-flexible substrate 1210. Floor 1110 of base 1100 is shown to be touching the surface with planar contact, due to the stabilizing contour of bottom 1216, making substrate 1210 more stable and less prone to tipping.

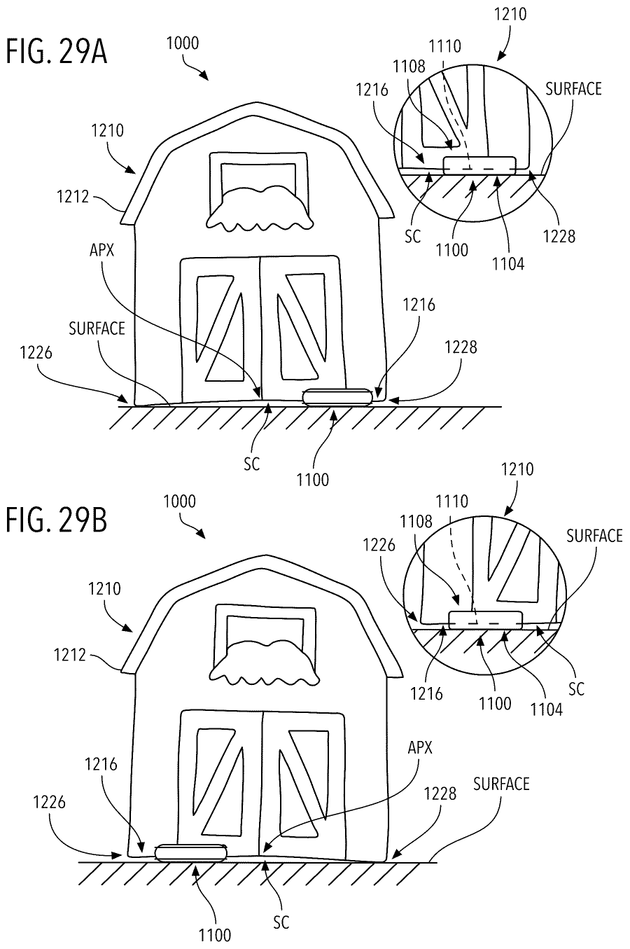

FIGS. 29A and 29B, which may be contrasted to FIGS. 27C and 27B, respectively, illustrates the reintroduction of stabilizing contour SC to the play character of FIGS. 27A through 27C. Specifically, FIG. 29A shows character display system 1000 with base 1100 coupled to semi-flexible substrate 1210 proximate second bottom corner 1228 of bottom 1216. The stabilizing contour SC extends in an are along the continuous bottom 1216 to the play surface where first bottom corner 1226 contacts the play surface, stabilizing semi-flexible substrate 1210, unlike FIG. 27C. Likewise, in FIG. 29B, character display system 1000 is shown with base 1100 coupled to semi-flexible substrate 1210 proximate first bottom corner 1226 of bottom 1216. Stabilizing contour SC extends in an are along the continuous bottom 1216 to the play surface where second bottom corner 1228 contacts the play surface, stabilizing semi-flexible substrate 1210, unlike FIG. 27B. Unlike in FIGS. 27B and 27C, the bottom of base 1100 can rest flushly on the play surface due to stabilizing contour SC of bottom 1216.

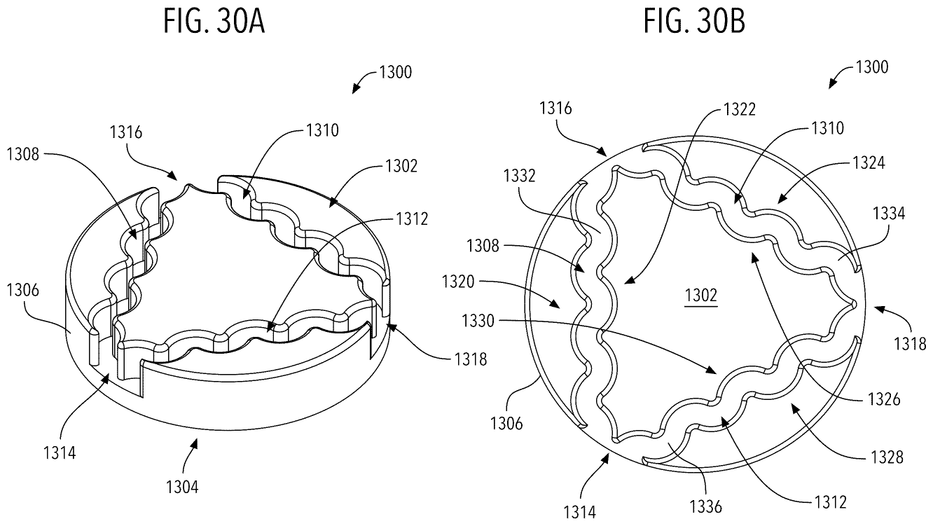

FIGS. 30A and 30B illustrate a first alternative embodiment of base 1100, base 1300, comprising top 1302, bottom 1304, outer wall 1306, first retention slot 1308, second retention slot 1310, and third retention slot 1312. First retention slot 1308 has first side opening 1314 and second side opening 1316, second retention slot 1310 has second side opening 1316 and third side opening 1318, and third retention slot 1312 has third side opening 1318 and first side opening 1314. First retention slot 1308 has first retention wall 1320 and second retention wall 1322, and floor 1332. Second retention slot 1310 has first retention wall 1324 and second retention wall 1326, and floor 1334. Third retention slot 1312 has first retention wall 1328 and second retention wall 1330, and floor 1336. Each of the first, second, and third retention slots (1308, 1310, 1312) are substantially similar to retention slot 1108 of base 1100 (See FIGS. 20A-20D), wherein the first retention wall (1320, 1324, 1328) and the second retention wall (1322, 1326, 1330) of each retention slot (1308, 1310, 1312) comprises a plurality of nodes and a plurality of depressions-giving each retention slot identical functionality as retention slot 1108. First retention slot 1308 and second retention slot 1310 share second side opening 1316. Second retention slot 1310 and third retention slot 1312 share third side opening 1318. Third retention slot 1312 and first retention slot 1308 share first side opening 1314. A connected inner wall is formed by second retention wall 1322 of first retention slot 1308, second retention wall 1326 of second retention slot 1310, and second retention wall 1330 of third retention slot 1312.

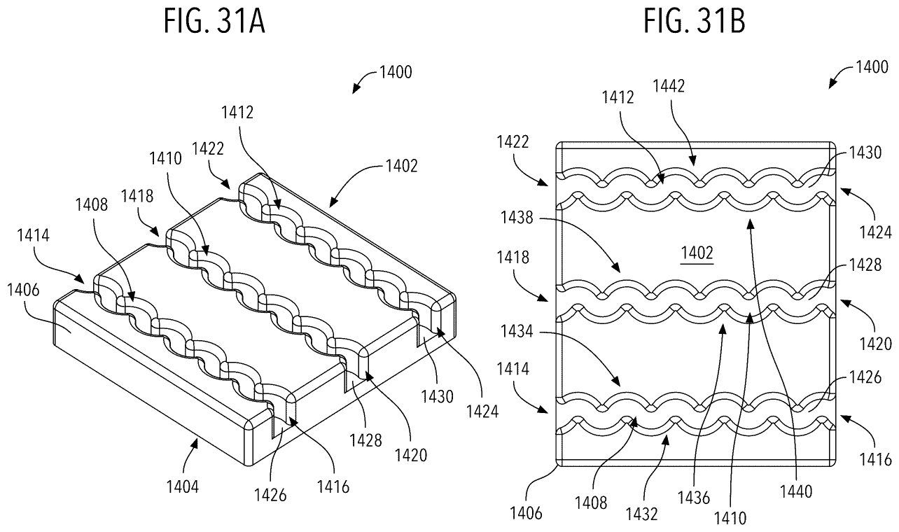

FIG. 31A and 31B illustrate a second alternative embodiment of base 1110, e.g., base 1410, comprising top 1402, bottom 1404, outer wall 1406, first retention slot 1408, second retention slot 1410, and third retention slot 1412. First retention slot 1408 has first side opening 1414 and second side opening 1416. Second retention slot 1410 has third side opening 1418 and fourth side opening 1420. Third retention slot 1412 has fifth side opening 1422 and sixth side opening 1424. First retention slot 1408 has floor 1426, second retention slot 1410 has floor 1428, and third retention slot 1412 has floor 1430. First retention wall 1432 and second retention wall 1434 of first retention slot 1408, first retention wall 1436 and second retention wall 1438 of second retention slot 1410, and first retention wall 1440 and second retention wall 1442 of third retention slot 1412 each comprise a plurality of nodes and a plurality of depressions, such that each of the first, second, and third retention slots (1408, 1410, 1412) are substantially similar to retention slot 1108 of base 1100. The first retention slot 1408, the second retention slot 1410, and third retention slot 1412 are spaced apart and parallel to one another.

In summary, the disclosure has presented several key aspects of the character display system, with different options for base 1100 and the play character, e.g., the semi-flexible substrate in its many possible configurations. These features work in conjunction to achieve a stable and customizable play experience. The configuration of retention slot 1108 of base 1100 (illustrated in FIGS. 20A-20D) creates a secure yet easily accessible connection with the play character, while bases 1300 and 1400 (illustrated in FIGS. 30A and 30B and FIGS. 31A and 31B, respectively) provides multiple slots for arranging a plurality of play characters within a single base. The stabilizing contour SC (illustrated in FIGS. 24-26B and 28A-29B) along the bottom edge of the play character works to ensure stability and prevent tipping, allowing the play character to maintain planar contact equilibrium with the play surface. Finally, the texturized surface (illustrated in FIGS. 22B and 22C) on at least one face of the play character enhances the adherence and customizability of the play character using dry-erase crayons.

It will be appreciated that various aspects of the disclosure above and other features and functions, or alternatives thereof, may be desirably combined into many other different systems or applications. Various presently unforeseen or unanticipated alternatives, modifications, variations, or improvements therein may be subsequently made by those skilled in the art which are also intended to be encompassed by the following claims.

### REFERENCE NUMERALS

10 Substrate
11 Design face of substrate 10
12 Mounting face of substrate 10
20 20 Outer border of substrate 10
21a, 21b Lines of demarcation of design face 11 of substrate 10
22a, 22b Shapes created by lines of demarcation 21a, 21b . . . and/or outer border 20
30 Marking
50 Screw positioning foam
51Adhesive release liner
52 Adhesive layer of screw positioning foam 50
53 Marking aperture of screw positioning foam 50
100 Star plate
101 Contoured external face
102 Internal face
103 Base
110 Star aperture
120 Plurality of tabs of star aperture 110
120a Tab of plurality of tabs 120
121 Contoured section of each tab of plurality of tabs 120
121a Contoured section of tab 120a
122 Rounded end of each tab of plurality of tabs 120
122a Rounded end of tab 120s
150 Self-centering section of plurality of tabs 120
200 Stud plate
201 External face of stud plate 200
202 Mounting face of stud plate 200
210 Stud of external face 201
211 Body of stud 210
212 Annular ring of body 211
212a Lip edge of annular ring 212
212b Curved edge of annular ring 212
220 Mounting aperture of stud plate 200
230 Mounting channel of mounting face 202
230a First edge of mounting channel 230
230b Second edge of mounting channel 230
230c Third edge of mounting channel 230
300 Mounting assembly
310 Mounting screw
400 Wall
401 Planar surface
500 Whiteboard
500a First design of whiteboard 500
500b Second design of whiteboard 500
500c Third design of whiteboard 500
500d Fourth design of whiteboard 500
500e Fifth design of whiteboard 500
500f Sixth design of whiteboard 500
600 Alternative embodiment of star socket 100
601 Contoured face of star socket 600
610 Star aperture of star socket 600
620 Plurality of tabs of star socket 600
621 Contoured section of each tab of plurality of tabs 620
622 End of each tab of plurality of tabs 620
650 Alternative embodiment of star socket 100
651 Contoured face of star socket 650
652 Star aperture of star socket 650
653 Plurality of tabs of star socket 650
654 End of each tab of plurality of tabs 653
655 Contoured section of each tab of plurality of tabs 653
700 Alternative embodiment of stud plate 200
701 External face of stud plate 700
710 Dynamic stud 710
711 Plurality of dynamic protrusions of dynamic stud 710
711a Plurality of channels of dynamic stud 710
712 Body of each of plurality of dynamic protrusions 711
713 Lip of body 712
714 Rounded end of body 712
715 Internal surface of each of plurality of dynamic protrusions 711
720 Aperture of stud plate 700
721 Outer perimeter of aperture 720
800 Alternative embodiment of star socket 100
801 Contoured face of star socket 800
810 Aperture of star socket 800
811 Outer edge of aperture 810
812 Internal surface of aperture 810
821 Contoured section of contoured face 801
900 Alternative embodiment of star socket 100
901 Contoured face of star socket 900
902 Internal face of star socket 900
903 Base of star socket 900
903a Aperture body base
904 Aperture body
920 Aperture
923 Outer perimeter of aperture 920
923a Inner surface of aperture 920
924 First tension wire
925 Second tension wire
926 Wire channel
1000 Character display system
1010 Semi-flexible substrate
1012 Outer edge
1014 Top
1016 Bottom
1016a Bottom section
1016b Bottom section
1020 Design face
1022 Rear face
1024 Indicia
1026 Texturized surface
1028 Dry-erase coating layer
1030 Rolling mountain undulation
1032 Valley undulation
1100 Base
1102 Top
1104 Bottom
1106 Outer wall
1108 Retention slot
1110 Floor
1112 First retention wall
1114 Second retention wall
1116 First side opening
1118 Second side opening
1120 Top opening
1122 First node
1124 Second node
1126 Third node
1128 Fourth node
1130 First depression
1132 Second depression
1134 Third depression
1136 Fifth node
1138 Sixth node
1140 Seventh node
1142 Eighth node
1144 Fourth depression
1146 Fifth depression
1148 Sixth depression
1210 Semi-flexible substrate
1212 Outer edge
1214 Top
1216 Bottom
1220 Design face
1222 Rear face
1224 Indicia
1226 First bottom corner
1228 Second bottom corner
1300 Base
1302 Top
1304 Bottom
1306 Outer wall
1308 First retention slot
1310 Second retention slot
1312 Third retention slot
1314 First side opening
1316 Second side opening
1318 Third side opening
1320 First retention wall of first retention slot
1322 Second retention wall of first retention slot
1324 First retention wall of second retention slot
1326 Second retention wall of second retention slot
1328 First retention wall of third retention slot
1330 Second retention wall of third retention slot
1332 Floor of first retention slot
1334 Floor of second retention slot
1336 Floor of third retention slot
1400 Base
1402 Top
1404 Bottom
1406 Outer wall
1408 First retention slot
1410 Second retention slot
1412 Third retention slot
1414 First side opening
1416 Second side opening
1418 Third side opening
1420 Fourth side opening
1422 Fifth side opening
1424 Sixth side opening
1426 Floor of first retention slot
1428 Floor of second retention slot
1430 Floor of third retention slot
1432 First retention wall of first retention slot
1434 Second retention wall of first retention slot
1436 First retention wall of second retention slot
1438 Second retention wall of second retention slot
1440 First retention wall of third retention slot
1442 Second retention wall of third retention slot
APX Apex
CP Center point of base 103
CP2 Center point of stud 210
F1 Funneling configuration of 121
F2 Funneling configuration of 121
LCP Lowest contact point
SC Stabilizing contour

What is claimed is:

1. A whiteboard, comprising:
a semi-flexible substrate having an outwardly facing design surface of a first color and an opposing inwardly facing surface, said outwardly facing design surface having an outer border about the entire perimeter thereof, said outer border comprising printed indicia of a second color which contrasts with said first color, wherein said outer border defines the shape of an object, said outwardly facing design surface further comprising at least one inner border, wherein said at least one inner border intersects at least said outer border at two points, or intersects at least one inner border at one point and said outer border at one point, or intersects at least one other inner border at one point and a different inner border at a second point, wherein each of said at least one inner border comprises printed indicia of a third color which contrasts with said first color, wherein said inner and outer borders intersect one another in such a way as to create discrete portions of said design surface and function as to create lines of demarcation between adjacent portions to define a surface area of said portions to be filled with a specific color of removable printed indicia.

2. A character display system comprising the whiteboard recited in claim 1 and further comprising:
a base adapted to removable accept the whiteboard therein, the base comprising:
a body with a top face and a bottom face; and,
a contoured retention slot arranged within the top face of the body and having a pair of openings arranged on peripheral edges of the body.

3. The character display system of claim 2, wherein the contoured retention slot comprises a first internal wall, a second internal wall, and a floor, one or more of the first internal wall or the second internal wall having at least one contact node extending therefrom.

4. The character display system of claim 2, wherein the contoured retention slot comprises a first internal wall, a second internal wall, and a floor, each of the internal walls having at least one contact node extending therefrom.

5. The character display system of claim 2, wherein the whiteboard comprises a bottom edge, the bottom edge configured with a stabilizing contour defined by a non-linear arrangement of the bottom edge.

6. A character display system, comprising:
a play character comprising:
a semi-flexible substrate;
printed indicia forming an internal design on the semi-flexible substrate, wherein an outer edge of the semi-flexible substrate forms a design outline, and wherein the internal design and the design outline form a first character; and,
a stabilizing base contour extending from lowest bottom corners upward to a middle point along the bottom edge of the semi-flexible substrate; and,
a base comprising:
at least one contoured retention slot configured to receive the play character, the contoured retention slot comprising a plurality of contact nodes.

7. The character display system of claim 6, wherein the semi-flexible substrate comprises a semi-flexible polymeric material.

8. The character display system of claim 6, wherein the stabilizing base contour is configured to maintain planar contact equilibrium with a play surface.

9. The character display system of claim 6, wherein the play character further comprises a dry-erase coating on at least one face.

10. The character display system of claim 9, wherein the dry-erase coating is configured to be compatible with dry-erase markers and dry-erase crayons.

11. The character display system of claim 9, wherein at least one face with the dry-erase coating has a textured surface configured to enhance adherence of dry-erase crayons.

12. The character display system of claim 11, wherein the textured surface comprises a plurality of irregularities.

13. A character display system, comprising:
a play character comprising:
a semi-flexible substrate; and,
printed indicia forming an internal design on the semi-flexible substrate, wherein an outer edge of the semi-flexible substrate forms a design outline, and wherein the internal design and the design outline form a first character; and,
a base comprising:
at least one contoured retention slot configured to receive the play character, the contoured retention slot comprising a first wall, a second wall, and a floor, wherein one or more of the first wall or the second wall comprise one or more contact nodes.

14. The character display system of claim 13, wherein the play character further comprises a stabilizing base contour extending from lowest bottom corners upward to a middle point along an are, at least a portion of the bottom edge of the semi-flexible substrate being arranged on the are of the stabilizing base contour.

15. The character display system of claim 13, wherein the play character further comprises one or more of:
a dry-erase coating on at least one face; or,
a textured surface configured to enhance adherence of dry-erase crayons on the at least one face.

16. The character display system of claim 15, wherein the textured surface comprises a plurality of irregularities.

17. The character display system of claim 16, wherein the plurality of irregularities comprise teeth.

18. The character display system of claim 17, wherein each of the teeth are configured as a rolling mountain.

19. The character display system of claim 16, wherein the plurality of irregularities on the textured surface have one or more of:
an average spacing between 5 micrometers and 20 micrometers; or,
an average height between 1 micrometer and 10 micrometers.

20. The character display system of claim 13, wherein the base comprises:
three contoured retention slots forming three side openings in the base such that each side opening is connected to two of the three contoured retention slots, each of the contoured retention slots having a first wall, a second wall, and a floor, wherein one or more of the first wall or the second wall comprise one or more contact nodes; or,
three contoured retention slots being spaced apart and substantially parallel, each of the three contoured retention slots having a pair of side openings within the base, each of the contoured retention slots having a first wall, a second wall, and a floor, wherein one or more of the first wall or the second wall comprise one or more contact nodes.
